(19) United States
(12) Patent Application Publication
(10) Pub. No.: US 2016/0209441 A1
(43) Pub. Date: Jul. 21, 2016

(54) CAPACITIVE, PAPER-BASED ACCELEROMETERS AND TOUCH SENSORS

(71) Applicant: President and Fellows of Harvard College, Cambridge, MA (US)

(72) Inventors: Aaron David MAZZEO, Cambridge, MA (US); Lawrence CHAN, Brooklyn, NY (US); William Bell KALB, Cambridge, MA (US); Xinyu LIU, Montreal (CA); Brian Anthony MAZZEO, Provo, UT (US); George McClelland WHITESIDES, Newton, MA (US)

(73) Assignee: President and Fellows of Harvard College, Cambridge, MA (US)

(21) Appl. No.: 14/258,166

(22) Filed: Apr. 22, 2014

Related U.S. Application Data
(63) Continuation of application No. PCT/US12/62189, filed on Oct. 26, 2012.
(60) Provisional application No. 61/552,992, filed on Oct. 28, 2011.
(60) Provisional application No. 61/552,990, filed on Oct. 28, 2011.

(51) Int. Cl. G01P 15/125; G06F 3/044

(52) U.S. Cl. CPC G01P 15/125; G06F 3/044; G06F 2203/04103; G06F 2203/04112

(57) ABSTRACT

Accelerometers and capacitive touch sensors fabricated from inexpensive, lightweight, disposable substrate materials, such as paper, are provided. These can be fabricated using simple technologies, such as laser cutting and screen printing. In one embodiment, a touch sensor includes a parallel plate capacitor having a fixed plate formed of a substrate material having a conductive layer and a deflectable plate formed of a paper substrate material having a conductive layer. In a second embodiment, a touch sensor includes a parallel plate capacitor formed of an exterior conductive layer deposited on a paper substrate material and an interior conductive layer deposited on a substrate material. In a third embodiment, a touch sensor includes an active electrode and a grounded electrode patterned on the surface of a paper substrate material. In another embodiment, an accelerometer includes a parallel plate capacitor containing a fixed plate and a free plate containing a paper substrate. Upon an applied acceleration, the distance between the plate of the parallel plate capacitor in an accelerometer changes, eliciting a change in the capacitance of the sensor. Measurement of capacitance can be correlated to the acceleration or deceleration applied to the accelerometer.

### CROSS REFERENCE TO RELATED APPLICATIONS

This application is a continuation application of PCT/US2012/062189 filed Oct. 26, 2012 which claims the benefit of priority to U.S. Provisional Application No. 61/552,990, filed Oct. 28, 2011, and U.S. Provisional Application No. 61/552,992, filed Oct. 28, 2011, the contents of which are incorporated in their entirety by reference.

### STATEMENT REGARDING FEDERALLY SPONSORED RESEARCH OR DEVELOPMENT

This work was supported in part by the Defense Advanced Research Projects Agency (DARPA) N/MEMS S&T Fundamentals Program under grant no. N66001-1-4003 issued by the Space and Naval Warfare Systems Center Pacific (SPAWAR) to the Micro/nano Fluidics Fundamentals Focus (MF3) Center. The Government has certain rights in the invention.

### FIELD OF THE INVENTION

The present invention relates to two and three dimensional capacitive, paper-based accelerometers and touch sensors which are highly economical and easy to manufacture and use.

### BACKGROUND OF THE INVENTION

Accelerometers are sensors which can measure acceleration or deceleration along one or more axes. Though accelerometers can have many designs, accelerometers typically include a suspended proof mass (also known as a seismic mass) suspended by one or more flexural springs and a means of measuring the displacement of the proof mass with respect to a stationary reference frame. When subjected to acceleration, the proof mass moves relative to the stationary reference frame and, when the acceleration ends, the proof mass returns to its initial position. The displacement of the proof mass due to acceleration is converted into an electrical output by various types of transducers, providing a measure of acceleration.

Accelerometers are widely used in motion sensing applications. Accelerometers have found applications in the automotive industry, where they are used to detect collisions and trigger airbag deployment. Accelerometers are also used in consumer electronics, including cellular phones and video game controllers, medical devices, such as automated external defibrillators, and sensors in building and structural monitoring.

Conventional accelerometers are typically fabricated from silicon-based materials, such as single crystal silicon, polycrystalline silicon, silicon dioxide, and silicon nitride, using modified semiconductor device fabrication technologies, normally used to make integrated circuits. These technologies include molding and plating, wet etching, dry etching, such as reactive-ion etching (RIE) and deep reactive-ion etching (DRIE), and electro-discharge machining (EDM). While these fabrication strategies can produce silicon-based accelerometers which exhibit excellent device performance, they are typically time consuming, require costly materials, and must be conducted in a cleanroom environment. As a result, conventional accelerometers are relatively costly to produce, limiting their potential use in many applications.

Touch sensors are devices which are activated by pressure and/or the proximity of a human finger. Touch sensors are widely used in a variety of electronic devices, where they are integrated into user interfaces such as keyboards, touchpads, and switches. Typically, touch sensors are fabricated from materials such as textiles, plastics, silicon, metal, and glass.

As the size and cost of electronic devices decrease, electronics are frequently being incorporated into a variety of low cost and/or disposable products, including single-use biomedical assays, interactive games, and smart packaging. Successfully deploying these goods into the marketplace will require low-cost, pliable user interfaces capable of accompanying these low cost devices to market. Suitable interfaces will preferably be low cost, portable, and/or readily integrated into a wide variety of commercial products.

Electronic devices are also increasingly used in settings where the transmission of infectious agents is a significant problem. For example, electronic devices, ranging from medical devices in operating rooms to personal computers used to access and update electronic medical records, are used in healthcare settings. Because healthcare professionals routinely come into contact with both patients and the user interfaces of electronic devices, the user interfaces of electronic devices can facilitate the spread of infectious agents. Disposable user interfaces, which can be routinely replaced and discarded, could serve to mitigate the spread of infectious agents. Suitable disposable interfaces will preferably be low cost, made from renewable materials, and/or be biodegradable.

Therefore, it is an object of the invention to provide accelerometers and touch sensors which are inexpensive, simple to fabricate, lightweight, and/or disposable.

It is also an object of the invention to provide assemblages of touch sensors, in the form of keyboards and touchpads, which are useful in a variety of commercial applications.

It is a further object of the invention to provide methods of manufacturing accelerometers and touch sensors, using inexpensive, lightweight, and/or disposable substrates such as paper.

### SUMMARY OF THE INVENTION

Accelerometers and capacitive touch sensors fabricated from inexpensive, lightweight, disposable substrate materials, such as paper, as well as methods of making and using thereof, are provided. These can be fabricated using simple and inexpensive technologies, such as laser cutting and screen printing.

The accelerometers contain a parallel plate capacitor formed from a free plate having a conductive surface suspended parallel to a fixed plate having a conductive surface, such that the conductive surfaces of the free plate and the fixed plate are facing one another, and the conductive surfaces are separated by some distance. The free plate is suspended by one or more flexural springs, such that the free plate is able to be deflected relative to the fixed plate when subjected to acceleration or deceleration. Deflection of the free plate alters the distance between the fixed plate and the free plate, resulting in a change in capacitance. Measurement of the capacitance can thus be correlated to the acceleration or deceleration applied to the accelerometer.

The accelerometers can be formed by adhering three layers of substrate material. One substrate layer, termed the fixed layer, is patterned and coated so as to contain a fixed plate. Another substrate layer, termed the deflectable layer, is fabricated to contain a stationary region, a free plate, and one or more flexural springs. A third substrate layer, i.e., the spacer layer, functions to provide distance between the fixed layer and the deflectable layer. The spacer layer ensures that the fixed plate and the free plate are separated by a suitable distance so as to form a parallel plate capacitor. The spacer layer is fabricated such that no substrate material is present in the region of the substrate layer located between the fixed plate and the free plate. The accelerometer can be formed by adhering a fixed layer, a spacer layer, and a deflectable layer together in the appropriate orientation so as to form a parallel plate capacitor.

Using this method, linear accelerometers, capable of measuring acceleration along only one axis (i.e., perpendicular to the axis of the parallel plate capacitor) can be formed. In further embodiments, multiple linear accelerometers are arranged to form a two-dimensional or three-dimensional accelerometer. For example, multiple linear accelerometers can be arranged in a 3-dimensional, orthogonal configuration to measure acceleration simultaneously along two (x-y) or three axes (x-y-z). These arrangements are facilitated by the substrate material, which can be readily folded to position the accelerometers orthogonally.

There are three principle embodiments of the touch sensors. In one embodiment, a touch sensor includes a parallel plate capacitor having a fixed plate formed of a substrate material having a conductive layer and a deflectable plate formed of a paper substrate material having a conductive layer. In a second embodiment, a touch sensor includes a parallel plate capacitor formed of an exterior conductive layer deposited on a paper substrate material and an interior conductive layer deposited on a substrate material. In a third embodiment, a touch sensor includes an active electrode and a grounded electrode patterned on the surface of a paper substrate material.

Capacitive, paper-based touch sensors register a change in capacitance in response to an applied force and/or the proximity of an object with a relatively large capacitance, such as the finger of a person. Capacitive, touch sensors can be fabricated to be mechanically compliant, meaning they register a change in capacitance when a force is applied to the surface of the sensor. Capacitive, touch sensors can also operate using capacitive coupling. In capacitive coupling sensors, the capacitance of the touch sensor can be perturbed when an object with a relatively large capacitance, such as the finger of a person, is brought into close proximity to the surface of the sensor. The touch sensor can also be designed so that an object contacting the touch sensor, such as the finger of a person, provides capacitive coupling between an active electrode and electrical ground. The touch sensors can be integrated with suitable electronic components for monitoring changes in capacitance.

Multiple independent touch sensors can be fabricated on a single piece of substrate material, forming an array of touch sensors which can be used as a touchpad or keyboard, such as a QWERTY keyboard. The touchpads and keyboards formed from these sensors are lightweight, flexible, inexpensive, and disposable. As a result, the touchpads and keyboards should be useful for a wide variety of applications ranging from smart packaging to medical devices to toys.

These devices are not only inexpensive to make due to the cheap materials, but can be fabricated for inexpensive application and storage. For example, in one embodiment, an array of touch sensors, such as a keyboard or touchpad, is fabricated on a roll which is then applied in a manner similar to pre-printed labels, with pre-applied or simultaneously applied adhesive. In another embodiment, an array of touch sensors, such as a keyboard or touchpad, is fabricated at the time of manufacture of an article, such as a medical device, toy, or shipping container.

### BRIEF DESCRIPTION OF THE DRAWINGS

FIGS. 1A-C are schematic drawings detailing the design and function of a capacitive, paper-based accelerometer affixed to the surface of an object. FIG. 1A shows a side view of a capacitive paper-based accelerometer in static equilibrium, where the two conductive surfaces are separated by a fixed distance (d₀). The fixed plate is shown at the bottom, affixed to the surface of an object. The free plate is suspended above the fixed plate by means of one or more flexural springs, such that the two plates are parallel to one another. FIG. 1B is a side view showing the effect of acceleration upon the accelerometer. As the device is accelerated upward from an initial state of rest, the free plate is deflected relative to the fixed plate, and the distance. FIG. 1C shows a top view of the free plate. The free plate is suspended above the fixed plate by flexural springs, which result from removing sections of the paper substrate material to form cantilevered regions connecting the free plate to a fixed border, which is integrated into the accelerometer so as to be non-deflectable when an acceleration is applied. (C₂>C₁).

FIGS. 2A-D illustrate a capacitive, paper-based touch sensor which operates based on mechanical compliance. The exemplary sensor is shown as being fabricated from metallized paper (used to construct the deflectable layer and the fixed layer) and double-sided carpet tape (used to construct the spacer layer). The metallized paper includes paper, a conductive layer, and a thin coating of polymer over the conductive layer to insulate the evaporated metal from the environment. FIG. 2A shows the components for a capacitive key on a touch pad based on mechanical compliance. FIG. 2B shows the assembled device shown in FIG. 2A. FIG. 2C shows mechanical deformation of an assembled device with an applied pressure. FIG. 2D shows the effective gap between the free and fixed plates (d₁) top and bottom layers decreases. This, which results in an a measurable increase in the capacitance which can be measured and correlated with the applied acceleration.

FIGS. 3A-H illustrate the design and function of two types (FIGS. 3A-D and E-H) of capacitive, paper-based touch sensors based on capacitive coupling. FIGS. 3A-D illustrate a capacitive coupling-based sensor where one electrode is positioned in proximity to the surface (i.e., the exterior conductive layer) and the second electrode is positioned within the interior of the sensor (i.e., the interior conductive layer). In this case, the sensor is designed to facilitate capacitive coupling between a finger in proximity to the surface of the touch sensor and one of the electrodes (i.e., the exterior conductive layer). FIG. 3A shows the components for a key on a touch pad based on capacitive coupling containing one electrode positioned in proximity to the surface (i.e., the exterior conductive layer) and a second electrode positioned within the interior of the sensor (i.e., the interior conductive layer). FIG. 3B shows the assembled capacitor from components shown in FIG. 3A. FIG. 3C shows that when a finger is brought into the proximity of the exterior conductive layer, the finger capacitively couples with the electrode, resulting in a measurable increase in capacitance. FIG. 3D shows a circuit diagram to describe the electrical coupling of the finger to the capacitive button. FIGS. 3E-H illustrate a capacitive coupling-based sensor where two electrodes (both the active electrode and the grounded electrode) are positioned in proximity to the surface. In this case, the sensor is designed such that an object contacting the touch sensor, such as a finger, provides capacitive coupling between the active electrode and the grounded electrode. The exemplary sensor is formed from a single sheet of metallized paper. The active and grounded electrodes were patterned on the metallized paper using a laser cutter to etch or ablate lines through the conductive metal layer of the metallized paper. FIG. 3E shows metallized paper used for single-layer touch pads. FIG. 3F shows etched or ablated lines through the conductive portion of the metallized paper designate regions or traces of conductance. FIG. 3G shows that a finger bridges the gap between an active electrode and a grounded electrode to cause a measurable change in capacitance. FIG. 3H is a diagram of the circuit to describe the electrical coupling between the electrodes through the finger.

FIGS. 4A-D illustrate the device components which make up an exemplary array of three touch sensors based on mechanical compliance. FIGS. 4A-D also illustrate the ability of the array to respond to pressure applied to one, two, or three discrete keys. FIG. 4A shows a layout of the device, which consists of chromatography paper (top and bottom layers), metallized paper, and a spacer. The device has a length (from left to right) of almost 100 mm, and each button is 25 mm×25 mm. FIG. 4B shows the electronics and software signal the depression of one key with the eraser of a pencil. FIG. 4C shows the system signals the simultaneous depression of two distinct keys. FIG. 4D shows the system signals the simultaneous depression of all three keys.

FIGS. 5A-D illustrate touch sensors based on capacitive coupling. FIGS. 5A-B illustrate a capacitive coupling-based sensor where one electrode is positioned in proximity to the surface (i.e., the exterior conductive layer) and the second electrode is positioned within the interior of the sensor (i.e., the interior conductive layer). The exemplary device is fabricated from two pieces of metallized paper and double-sided carpet tape. FIG. 5A shows the exterior conductive layer (labeled the top layer in FIG. 5A) was fabricated from Vacumet® A-238 (thickness of 56 microns). The exterior conductive layer was etched using a laser cutter to define the perimeter of an active region. The interior conductive later (labeled the bottom later in FIG. 5A) was fabricated from Vacumet A-550 (thickness of 137 microns). Manually cut pieces of double-sided tape were used to bind the pieces of metallized paper together. FIG. 5B is a photo of the button shown in FIG. 5A. FIG. 5B shows the capacitance (pF) of the button for two sets (touched with a bare finger and untouched) of seven measurements, each lasting five seconds and having more than 660 sampled points. The error bars are ±1 standard deviation. FIGS. 5C-5D illustrate a capacitive coupling-based sensor where two electrodes (both the active electrode and the grounded electrode) are positioned in proximity to the surface. In this case, the sensor is designed such that an object contacting the touch sensor, such as a finger, provides capacitive coupling between the active electrode and the grounded electrode. The exemplary sensor was fabricated from a single piece of Vacumet A-238 that was etched using a laser cutter to remove a portion of the conductive layer. A single piece of Vacumet A-238 was etched using a laser cutter to ablate a line of conductive material to form two regions of conductive material (i.e., electrodes) that are no longer in direct conductive contact. The two regions were fabricated in an inter-digitated fashion to form a button and increase the capacitive coupling between the electrodes when a finger is in proximity to the surface of the button.

FIGS. 6A-D illustrate the measured changes in capacitance (pF) over time (seconds) for the capacitive button shown in FIG. 5D after the button had already experienced more than 1000 touches. FIG. 6A shows measurements taken with a bare finger touching the button. The ticks and numbers show when the electronic system registered a capacitance greater than or equal to the threshold of 43 pF. FIG. 6B shows measurements taken with a gloved finger and the same threshold shown in A. FIG. 6C shows the distribution (general extreme value) of peak capacitances (pF) measured during 335 presses of the button with a bare finger. The data had a minimum measured peak at 270 pF. FIG. 6D is the distribution (normal) of peak capacitances (pF) measured during 504 presses of the button with a gloved finger. The mean was 65 pF±4 pF for 504, and the minimum peak measured was at 52 pF.

FIGS. 7A-C illustrate the change in capacitance of the button shown in FIG. 5E upon being touched. FIG. 7A shows the capacitance of a button increases when touched. To measure the change in capacitance of a button, a resistor was used in series with the capacitive button. FIG. 7B shows that while applying a step in potential (voltage) over time (microseconds) across the resistor-capacitor (RC) circuit, the potential across the capacitive button increases with a time constant equivalent to the product of the resistance and capacitance in the circuit. The required amount of time for the capacitor to charge to 2 V (threshold for Arduino® processor's input to go from 0 to 1) required time tᵣ*. For the shown measurement of the untouched button, tᵣ*=13 us. FIG. 7C shows that when touched, the capacitance across the button increased and tᵣ*=1300 us.

FIGS. 8A-D illustrate a 3-dimensional (3D) touchpad based on capacitive coupling where one electrode is positioned in proximity to the surface (i.e., the exterior conductive layer) and the second electrode is positioned within the interior of the sensor (i.e., the interior conductive layer). In this case, a touch pad based on capacitive coupling is fixed to the surface of a cube. The 3D touchpad produces measurable changes in capacitance when an external conductor (finger) makes contact with the surface of the touch sensor. FIG. 8A is a perspective drawing of the layout for six buttons, one button for each face, with dashed segments representing the folding lines. Each edge of the cube has a length of 38 mm. FIG. 8B shows the image and associated output for a finger touching the button on face number “1”. FIG. 8C shows the image and associated output for contact with button number “5”. FIG. 8D shows the image and associated output for contact with button number “6”.

FIGS. 9A-C illustrate a three-dimensional (3D) touchpad based on capacitive coupling where both the active electrodes and the grounded electrode are positioned in proximity to the surface. A touch pad based on capacitive coupling is fixed to the surface of a cube. The sensor is designed such that an object contacting the touch sensor, such as a finger, provides capacitive coupling between the active electrode and the grounded electrode. FIG. 9A shows the layout for six buttons—one button for each face. Each edge of the cube has a length of 38 mm. FIG. 9B is a photo of the cube and associated output for a bare finger touching the button on face number “2”. FIG. 9C is a photo of the cube and associated output where a gloved thumb and index finger making simultaneous contact with buttons number “5 and “2”.

FIGS. 10A-D illustrate the use of touch sensors based on capacitive coupling in smart packaging. In this case, touch sensors are used to create an “alarmed” cardboard box. The packaging includes electrodes capable of determining if the package has been opened as well as a touchpad for entering a code to arm the device. An Arduino® processor, 9-volt battery, two LEDs, a buzzer, a resistor, an operational amplifier, and a demultiplexer (demux) were also integrated into the packaging design. As designed, the box can be sealed and armed by entering a numerical code on the touchpad. The box can be disarmed by entering the code, and no alarm is triggered. However, when the box is opened without entering a code, an audible and visual alarm is triggered. FIG. 10A is a perspective view of the outside face of the box, where the paper-based touch pad had accompanying LEDs to provide feedback to the user. Both LEDs turned on when the alarm went off. In the upper left region, there was a capacitive switch to detect whether or not the box was open. FIG. 10B is a perspective view of the keypad and accompanying LEDs. The keypad had to receive the appropriate code to disable the alarm. The blue LED was designed to flash whenever a button was pushed. FIG. 10C is a close-up photo of the capacitive switch. FIG. 10D is a photo showing the required electronics inside the box for operating the alarm. The buzzer sounded when the alarm went off.

### DETAILED DESCRIPTION OF THE INVENTION

### I. Definitions

“Accelerometer”, as used herein, refers to a device which can be used to measure acceleration or deceleration along one or more axes. Linear accelerometers are accelerometers which calibrate between a given quantity (acceleration in this case) and its output (voltage in this case), which fall on a line with a fixed slope.

“Touch sensor”, as used herein, refers to a device which registers a measurable electronic response to an applied force and/or in response to the proximity of an object with a relatively large capacitance, such as the finger of a person.

“Parallel Plate Capacitor”, as used herein, refers to a capacitor formed by two parallel electrically conductive surfaces, termed plates, separated by a dielectric.

“Deflectable Plate” or “Free Plate”, as used herein, refers to a portion of substrate material containing a conductive layer that is incorporated into a touch sensor and is designed to be compliant in response to an applied mechanical force (i.e., to flex or deflect). A “Deflectable Layer”, as used herein, refers to a layer of substrate material for use in a touch sensor that is fabricated to contain one or more deflectable plates.

“Fixed Plate”, as used herein, refers to a region of the substrate material containing a conductive layer that is incorporated into a touch sensor, and that is designed to remain stationary (i.e., not to be deflected) relative to the other components of the touch sensor when a mechanical force is applied to the touch sensor. A “Fixed Layer”, as used herein, refers to a layer of substrate material for use in a touch sensor that is fabricated to contain one or more fixed plates.

“Substrate material”, as used herein, refers to the material that forms the structural components of the accelerometer or touch sensor, and to which the conductive surfaces and other electrical device components are applied.

“Proof mass”, as used herein, refers to a mass incorporated into or onto the deflectable plate of an accelerometer, which serves to deform the deflectable plate when the force sensor is subjected to an applied acceleration or deceleration.

“Conductive Surface”, as used herein, refers to the electrically conductive layer present in or on the substrate material which makes up the fixed plate or deflectable plate. In certain cases, the conductive surface is a conductive layer that is applied to or deposited on the surface of the substrate material which makes up the fixed plate or deflectable plate. The conductive surface can optionally be covered by an insulating material.

“Conductive layer”, as used herein, refers to the electrically conductive layer of a fixed place or deflectable plate. The conductive layer may be, for example, a conductive material which is applied or deposited on the surface of the substrate material. The conductive layer may also be present within the interior (i.e., not on the surface) of the fixed plate or the deflectable plate.

“Electrical device components”, as used herein, collectively refers to all elements of the accelerometer through which current flows. Electrical device components include the conductive surfaces of the fixed and free plates as well as additional elements which are patterned on the substrate materials to form an accelerometer, such as points of contact for an electrical lead or circuit, or elements of integrated signal-processing circuitry.

“Flexural Spring”, as used herein, refers to a region of substrate material, such as a cantilevered region, which connects the free plate to a stationary portion of the substrate material so as to provide the free plate the ability to be deflected when the accelerometer is subjected to an applied acceleration or deceleration.

“Cantilevered Region”, as used herein, refers to a region of the substrate material which is fabricated so as to have a high aspect ratio, and is connected to a fixed or stationary portion of the accelerometer at only one end. As a result, when an acceleration is applied to the accelerometer, one end of the cantilevered region is held stationary (i.e., the end of the cantilevered region anchored to a fixed portion of the accelerometer), while the other end of the cantilevered region (i.e., the end of the cantilevered region not anchored to a fixed portion of the accelerometer) is deflected. The deflectable end of the cantilevered region can be connected to the free plate, in which case the cantilevered region can function as a flexural spring. “Spacer Layer”, as used herein, refers to a layer of substrate material for use in an accelerometer or touch sensor that serves as a spacer between the fixed layer and the deflectable layer. The spacer layer ensures that the fixed plate and the free plate are separated by a suitable distance so as to form a parallel plate capacitor. The spacer layer is preferably fabricated such that no substrate material is present in the region of the layer located between the fixed plate and the deflectable plate.

“Insulating material”, as used herein, refers to any material which resists the flow of electric charge.

“Flexible”, as used herein, refers to a pliable material which can be substantially bent through its thinnest dimension and return to a flat configuration without damaging the integrity of the material

“Insulating material”, as used herein, refers to any material which resists the flow of electric charge.

“Electrical device components”, as used herein, collectively refers to all elements of the touch sensor through which current flows. Electrical device components include the conductive layers of fixed and deflectable plates, the active and grounded electrodes of capacitive coupling-based sensors, as well as additional elements which are patterned on the substrate materials to form a touch sensor, such as points of contact for an electrical lead or circuit, or elements of integrated signal-processing circuitry.

“Paper”, as used herein, refers to a web of pulp fibers that are formed, for example, from an aqueous suspension on a wire or screen, and are held together at least in part by hydrogen bonding. Papers can be manufactured by hand or by machine. Paper can be formed from a wide range of matted or felted webs of vegetable fiber, such as “tree paper” manufactured from wood pulp derived from trees, as well as “plant papers” or “vegetable papers” which include a wide variety of plant fibers (also known as “secondary fibers”), such as straw, flax, and rice fibers. Paper can be formed from substantially all virgin pulp fibers, substantially all recycled pulp fibers, or both virgin and recycled pulp fibers. Paper may include adhesives, fillers, dyes, or other additives.

“Fabric”, as used herein, refers to a textile structure composed of mechanically interlocked fibers or filaments. The fibers may be randomly integrated (non-woven), closely oriented by warp and filler strands at right angles to one another (woven), or knitted. The term fabric encompasses both natural fabrics (e.g., fabrics formed from naturally occurring fibers such as cotton, wool, and silk) and synthetic fabrics (e.g., fabrics formed at least partially from one or more synthetic fibers such as rayon, polyesters, and other synthetic polymers.

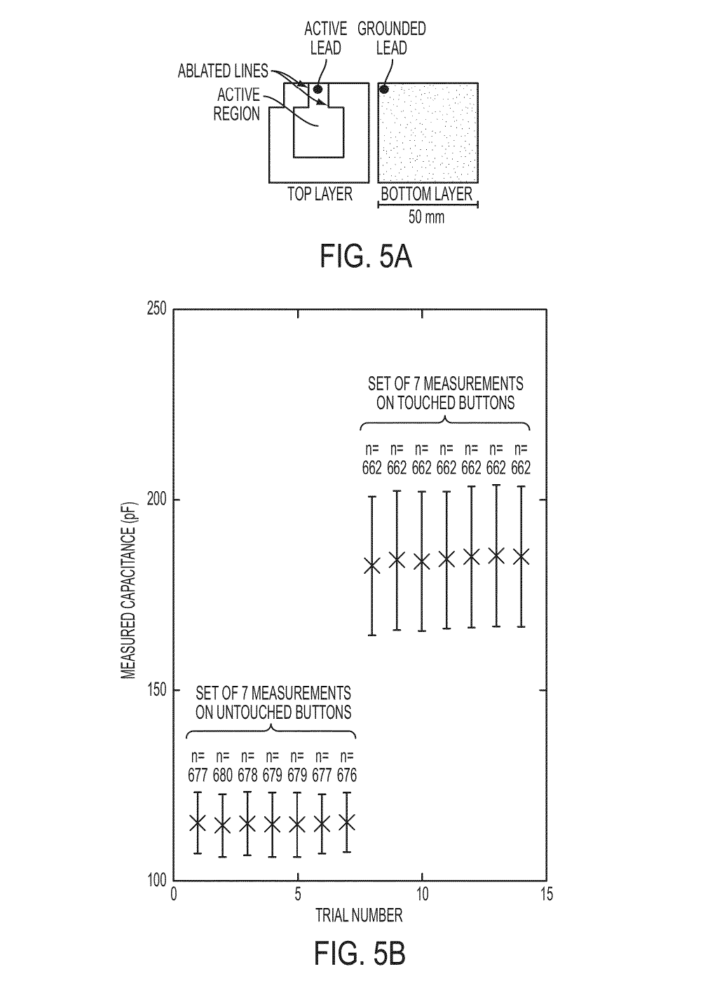

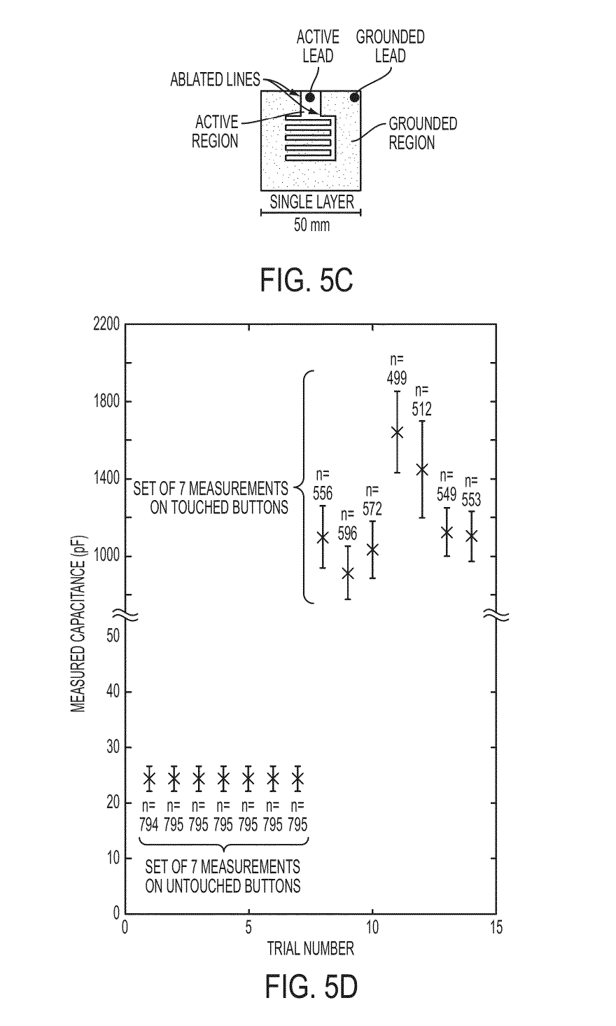

“Interdigitated” is used herein to describe two complementarily-shaped electrodes, wherein “branches” or “fingers” of each electrode are disposed in an alternating fashion. As shown in FIG. 5D, interdigitated electrodes are patterned to increase the length of the interface between the two electrodes, for example by forming multiple fingers which are arranged in an alternating fashion with respect to one another. Other interdigitated electrode shapes, in addition to the shapes illustrated in FIG. 5D, may also be suitable for use in touch sensors.

### II. Devices

Accelerometers and capacitive touch sensors fabricated using inexpensive, lightweight, and/or disposable substrates such as paper are described herein.

The accelerometers contain a parallel plate capacitor. In a parallel plate capacitor, two parallel conductive surfaces are separated by a dielectric medium, such as air. When there is a potential difference (voltage) across the conductors, a static electric field develops across the dielectric medium, causing positive charge to collect on one plate and negative charge on the other plate. The capacitance (measured in farads) of a parallel plate capacitor is dependent upon many variables, including the distance separating the two conductive surfaces.

In the case of the accelerometer, one conductive surface (i.e., the free plate) is fabricated so as to be deflected when the device is subjected to an acceleration or deceleration while the second conductive surface is held in a fixed position. As a result, acceleration or deceleration induces a change in the distance between the two plates of the parallel plate capacitor. Because the capacitance of the parallel plate capacitor varies based on the distance between the two conductive surfaces, the acceleration or deceleration induces a measurable change in capacitance. The capacitance of the accelerometer can be measured using any suitable method, and correlated with the acceleration or deceleration experienced by the accelerometer.

Touch sensors are based on the concept of a parallel plate capacitor. In a parallel plate capacitor, two parallel conductive plates are separated by a dielectric medium, such as air. When there is a potential difference (voltage) across the conductors, a static electric field develops across the dielectric medium, causing positive charge to collect on one plate and negative charge on the other plate. The capacitance (measured in farads) of a parallel plate capacitor is dependent upon many variables, including the distance separating the two conductive surfaces. For example, as the distance between the conductive plates in a parallel plate capacitor decreases, the capacitance increases. The capacitance scales with the inverse of the distance between the two conductive plates as defined in the following formula

$$C = \frac{k {ɛ}_{o} A}{d}$$

where k is the dielectric constant of the material separating the plates, ∈ₒ is the permittivity of free space (8.854×10⁻¹² F/m), A is the cross-sectional area of the plates, and d is the distance/gap between plates.

Capacitive, paper-based touch sensors register a change in capacitance in response to an applied force and/or the proximity of an object with a relatively large capacitance, such as the finger of a person. Capacitive, touch sensors can be fabricated to be mechanically compliant, meaning they register a change in capacitance when a force is applied to the surface of the sensor. Capacitive, touch sensors can also be designed to operate using capacitive coupling. In such sensors, the capacitance of the touch sensor is perturbed when an object with a relatively large capacitance, such as the finger of a person, is brought into close proximity to the surface of the sensor.

Touch sensors can also be designed to employ both mechanical compliance and capacitive coupling. In such embodiments, the touch sensor contains a deflectable external conductive surface and a fixed internal conductive surface. In these sensors, a change in capacitance can result from both an applied force and the proximity of an object with a relatively large capacitance, such as the finger of a person.

In some embodiments, the capacitive touch sensor has a total thickness of between 20 and 500 microns, more preferably between 25 and 400 microns, most preferably between 30 and 250 microns. In certain embodiments, the capacitive touch sensor has a total thickness of between 20 and 70 microns.

A. Accelerometer Design

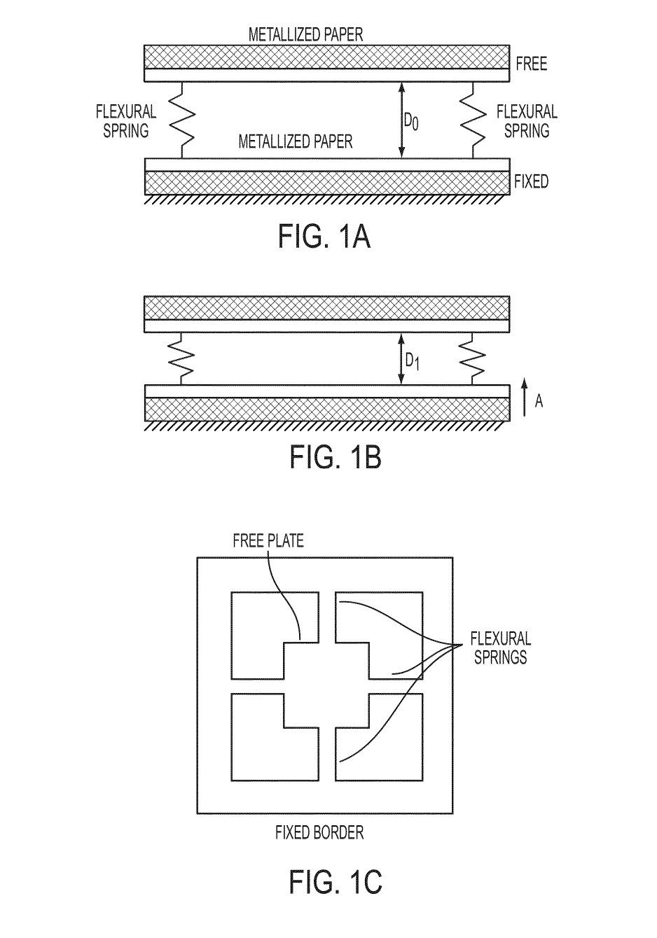

The design of a representative capacitive, paper-based accelerometer is detailed schematically in FIGS. 1A-C.

The accelerometer includes a fixed plate containing a first conductive surface and a free plate containing a second conductive surface. The fixed plate and free plate are arranged parallel to one another, such that the two conductive surfaces are facing one another and are separated by some distance, so as to form a parallel plate capacitor. The distance between the conductive surface of the fixed plate and the conductive surface of the free plate is selected so as to provide a capacitance suitable for device function. The distance is sufficient such that the two conductive surfaces do not come into contact as a result of the deflection of the free plate during accelerometer operation.

Typical ranges for distances between plates are from about 25 microns to 1 mm. Typical total height ranges from 250 microns to 3 mm. Lateral dimensions usually range from 5 mm to 75 mm.

The fixed plate is designed to remain stationary (i.e., not to be deflected) relative to the other components of the accelerometer when the accelerometer is subjected to an applied acceleration or deceleration.

In contrast, the free plate is designed to be deflected relative to the fixed plate when the accelerometer is subjected to an applied acceleration or deceleration. The free plate is typically suspended from a stationary region of substrate material by means of one or more flexural springs. In some cases, the flexural springs are connected to the free plate in a symmetrical fashion, so that when an external force is applied to the free plate perpendicular to the conductive surface, the free plate is deflected, decreasing or increasing the distance between the free plate and the fixed plate in a uniform fashion across the entire surface area of the free plate.

A representative embodiment is shown in FIG. 1C, in which a free plate is suspended within a fixed border of substrate material (i.e., a stationary region) by multiple cantilevered regions. The cantilevered regions are fabricated, for example, by removing substrate material from the deflectable layer. The cantilevered regions can have a high aspect ratio, typically an aspect ratio of greater than 3:1, greater than 4.5:1, or even greater than 6:1. For some applications at high frequencies, lower aspect ratios are preferred.

The cantilevered regions are connected to a stationary portion of the deflectable layer at one end, while the other end is attached to the free plate.

In one embodiment, the accelerometer architecture described above is formed by adhering three layers of substrate material. One substrate layer, termed the fixed layer, is patterned and coated so as to contain a fixed plate. Another substrate layer, termed the deflectable layer, is fabricated to contain a stationary region, a free plate, and one or more flexural springs. A third substrate layer, i.e., the spacer layer, functions to provide distance between fixed layer and the deflectable layer. The spacer layer ensures that the fixed plate and the free plate are separated by a suitable distance so as to form a parallel plate capacitor. The spacer layer is fabricated such that no substrate material is present in the region of the layer located between the fixed plate and the free plate. An accelerometer can be formed by adhering a fixed layer, a spacer layer, and a deflectable layer together in the appropriate orientation so as to form a parallel plate capacitor.

In some embodiments, the accelerometer is formed from fewer than three layers of substrate material. In one embodiment, a single piece of substrate material is fabricated to contain a free plate, a fixed plate, and a spacer region (e.g., where no substrate material is present). The substrate material can then be folded to align the free plate, spacer region, and free plate so as to form a parallel plate capacitor.

The accelerometer can further contain one or more additional layers, including protective layers designed to protect the device from damage, wear, or environmental influence.

Both the free plate and the fixed plate contain a conductive surface. Generally, the conductive surface will be a thin coating applied to one side of the substrate material. The conductive surface can be formed from any suitable conductive material, such as a metal (for example, Sn, Zn, Au, Ag, Ni, Pt, Pd, Al, In, Cu, and alloys thereof) graphite powder, or carbon black. The coating will preferably be of uniform thickness. In preferred embodiments, the conductive surface is a thin metallic film which is less than about 100 nm in thickness, more preferably less than about 25 nm in thickness. Studies have all been conducted with a metallic thickness of less than 20 nm. In some embodiments, the conductive surface is covered by an insulating material, such as plastic or paper.

In some embodiments, a proof mass may be incorporated into the free plate. A proof mass is affixed to the free plate, for example using an adhesive. The proof mass can be fabricated from the substrate material, or can be formed from another material, such as a metal or plastic.

In some embodiments, one or more electrical device components (in addition to the conductive surfaces) are incorporated into the accelerometer. In some embodiments, conductive materials are patterned on or through one or more substrate materials so as to facilitate contact on the conductive surfaces with electrical leads, wires, or circuit components.

In some cases, the accelerometer is connected via electrical leads to one or more signal processing components used to measure capacitance, such as a capacitance meter (i.e., a two-chip approach). In some embodiments, a signal-processing circuit, such as a bridge circuit, is integrated into the accelerometer. In such cases, the signal processing circuit can be placed directly on the surface of the substrate material using methods described below, integrating the signal processing circuit with the device (i.e., a one-chip approach).

1. Two-Dimensional and Three-Dimensional Accelerometers

The accelerometer described above is capable of measuring acceleration along only one axis (i.e., perpendicular to the axis of the parallel plate capacitor. However, some applications necessitate the simultaneous measurement of acceleration along more than one axis.

In some embodiments, multiple accelerometers, such as those described above, are arranged to form a two-dimensional or three-dimensional accelerometer. For example, multiple linear accelerometers can be arranged in a 3-dimensional, orthogonal configuration to measure acceleration simultaneously along two (x-y) or three axes (x-y-z). These arrangements are facilitated by the substrate material, which can be readily folded to position the accelerometers orthogonally

In some embodiments, multiple accelerometers can be connected as faces of a closed cubical structure. The cubical structure can, for example, incorporate three accelerometers within three different faces of the cube, such that one accelerometer is located to measure acceleration or deceleration along each axis. Such an arrangement permits measurement of acceleration or deceleration in three orthogonal directions (x-y-z). For embodiments where measurement of acceleration or deceleration is desired along only two axes, a closed cubical structure can be formed with linear accelerometers located on two faces of the cube. The cubic architecture advantageously provides increased structure and strength to the paper-based accelerometer. In some cases, multiple accelerometers and electrical elements are first fabricated and then folded into a 3-dimensional, orthogonal configuration.

B. Touch Sensor Design

1. Touch Sensors Based on Mechanical Compliance

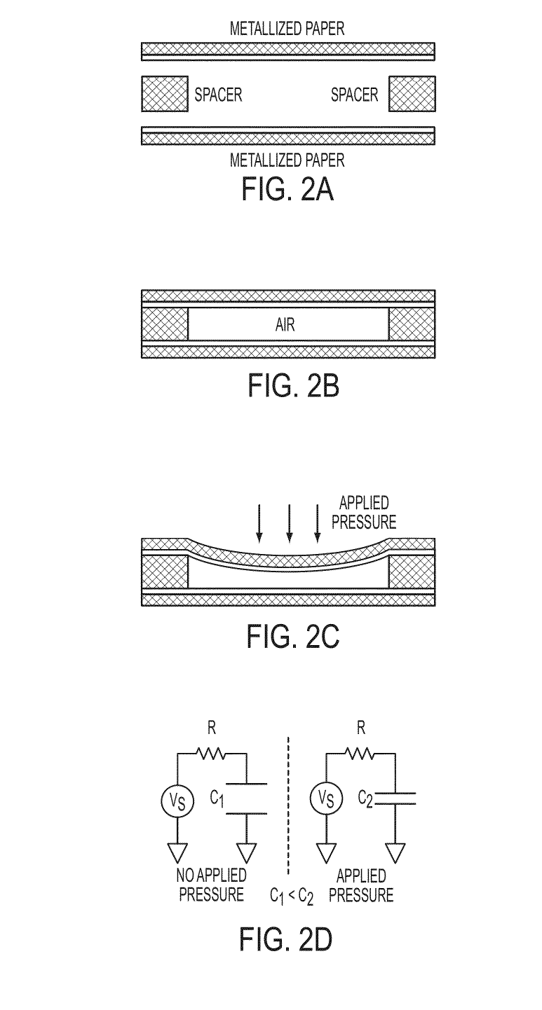

Touch sensors can be fabricated which respond to mechanical deformation resulting from the applied force of a user pressing on the surface of the sensor. Such devices are termed mechanically compliant. A representative touch sensor which responds to mechanical deformation is shown in FIGS. 2A-D.

Mechanically compliant touch sensors contain a deflectable plate having a conductive layer positioned parallel to a fixed plate having a conductive layer, such that the conductive layers are separated by some distance to form a parallel plate capacitor. The distance between the conductive layer of the fixed plate and the conductive layer of the deflectable plate is selected so as to provide a capacitance suitable for device function. In the event that the two conductive layers are conductive surfaces, the distance between the conductive layers is sufficient such that the two conductive layers will not come into contact as a result of the deflection of the deflectable plate during mechanical deformation. In certain embodiments, the distance between the conductive layer of the deflectable plate and the conductive layer of the fixed plate is between 10 and 500 microns, more preferably between 25 and 400 microns, most preferably between 45 and 350 microns. In some embodiments, the distance between the conductive layer of the deflectable plate and the conductive layer of the fixed plate is between 45 and 55 microns. In other embodiments, the distance between the conductive later of the deflectable plate and the conductive layer of the fixed plate is between 330 and 350 microns.

The fixed plate is designed to remain stationary (i.e., not to be deflected) relative to the other components of the touch sensor when a force is applied to the surface of the touch sensor. In contrast, the deflectable plate is designed to be deflected relative to the fixed plate when a mechanical force is applied to the surface of the touch sensor. When a force is applied to the surface of the touch sensor, the deflectable plate flexes, decreasing the distance between the fixed plate and the deflectable plate, and increasing the capacitance. Measurement of the capacitance can thus be correlated to the force applied to the surface of the touch sensor.

Touch sensors based on mechanical compliance can be formed from one or more layers of patterned substrate material. In certain cases, the touch sensors are formed by adhering three layers of patterned substrate material. One substrate layer, termed the fixed layer, is patterned and/or coated so as to contain a fixed plate. Another substrate layer, termed the deflectable layer, is fabricated to contain a deflectable plate. A third substrate layer, termed the spacer layer, functions to provide distance between fixed layer and the deflectable layer. Touch sensors based on mechanical compliance can be formed by adhering a fixed layer, a spacer layer, and a deflectable layer together in the appropriate orientation so as to form a parallel plate capacitor.

The spacer layer ensures that the fixed plate and the deflectable plate are separated by a suitable distance so as to form a parallel plate capacitor. The spacer layer is preferably fabricated so that no substrate material is present in the region of the layer located between the fixed plate and the deflectable plate. Alternatively, the spacer layer can be fabricated such that substrate material is present in the region of the layer located between the fixed plate and the deflectable plate. In these embodiments, the substrate material forming the spacer layer is a compressible solid or foam, and has a suitable dielectric constant for sensor function.

The touch sensor can further contain one or more additional layers, including protective substrate layers designed to protect the device from damage, wear, or environmental influence. These protective layers can be fabricated from any suitable material. In some embodiments, one or more additional layers of paper are incorporated in the touch sensor to provide additional protection or rigidity to the device. In certain embodiments, one or more additional layers of a hydrophobic substrate material are incorporated into the touch sensors to protect the sensor from environmental influence. Suitable hydrophobic substrate materials include, but are not limited to, hydrophobically modified paper, wax paper, and hydrophobic plastic thin films. In some cases, one or more layers of substrate material containing graphics or text, for example to indicate the function of the touch sensor.

Both the fixed plate and the deflectable plate contain a conductive layer. The conductive layer can be formed from any suitable conductive material, such as a metal (for example, Sn, Zn, Au, Ag, Ni, Pt, Pd, Al, In, Cu, and alloys thereof), graphite powder, or carbon black. The conductive layer will preferably be of uniform thickness. In certain embodiments, the conductive layer is a thin metallic film which is less than 10 microns in thickness, more preferably less than 1 micron in thickness, more preferably less than 100 nm in thickness, more preferably less 50 nm in thickness, still more preferably less than 25 nm in thickness, and most preferably less than 20 nm in thickness.

The conductive layer can be a conductive surface present on a fixed plate and/or a deflectable plate. The conductive layer can alternatively be present within the interior of a fixed plate and/or a deflectable plate. In some embodiments, the conductive layer is a thin conductive coating (i.e., a conductive surface) applied to one side of the substrate material. In some embodiments, the conductive surface is covered by one or more insulating materials, such as one or more layers of plastic or paper. In these embodiments, the conductive layer is present within the interior of the substrate material.

In some embodiments, one or more electrical device components (in addition to the conductive layers) is incorporated into the touch sensor. In some embodiments, conductive materials are patterned on or through one or more substrate materials so as to facilitate contact of the conductive layers with electrical leads, wires, or circuit components.

In some cases, the touch sensor is integrated into an RC circuit, as shown in FIG. 2D, which is used to monitor changes in capacitance. As the capacitance of the touch sensor increases, the time required to fully charge the capacitor with an applied voltage (Vₛ) increases. At sufficiently high oscillatory frequencies dictated by the RC time constant (the product of resistance and capacitance), the potential across the capacitor lags that of the oscillating potential (Vₛ). The lagging behavior results in a measured attenuation of the potential across the capacitor (i.e., the applied voltage switches direction before the capacitor can fully charge). In certain embodiments, the measured attenuation of the potential across the capacitor is correlated with the force applied to the surface of the touch sensor, so as to quantify the force applied to the surface of the touch sensor.

In preferred embodiments, the touch sensor operates as a switch (such as an on/off switch or a key in a keyboard). In these embodiments, the potential across the capacitor is monitored, and when the attenuated potential across the capacitor falls below one or more preselected thresholds, the electronics signal the activation of one or more switches. In some embodiments, the threshold value is 95%, 90%, 85%, 80%, 75%, or 70% of the potential across the untouched capacitive system. The threshold value will be selected so as to provide the desired on-off sensitivity for the touch sensor, and can vary depending upon application. In some embodiments, such as toys, relatively large threshold values (e.g., greater than 90%) may be used, so as to create a more sensitive switch. In other embodiments, such as medical devices, relatively low threshold values (e.g., less than 75%) may be used, so as to create a touch sensor which is less sensitive. The use of a less sensitive touch sensor in the medical device may decrease the risk of a user accidentally triggering the switch.

2. Touch Sensors Based on Capacitive Coupling

Capacitive, touch sensors can also operate using capacitive coupling. Capacitive coupling-based sensors exhibit a change in capacitance when an object with a relatively large capacitance, such as the finger of a person, is brought into close proximity to the surface of the sensor. Capacitive coupling-based touch sensors contain an active electrode and a grounded electrode. At least one of the electrodes is positioned in proximity to the surface, such that the electrode is able to capacitively couple with an object, such as a finger, on or near the surface of the touch sensor.

In some embodiments, the capacitive coupling-based touch sensor contains one electrode positioned in proximity to the surface (termed the exterior conductive layer) and a second electrode positioned within the interior of the sensor (termed the interior conductive layer). In this case, the sensor is designed to facilitate capacitive coupling between a finger in proximity to the surface of the touch sensor and one of the electrodes (i.e., the exterior conductive layer).

In other embodiments, the touch sensor contains two electrodes (both the active electrode and the grounded electrode) positioned in proximity to the surface. In this case, the sensor is designed such that an object contacting the touch sensor, such as a finger, provides capacitive coupling between the active electrode and the grounded electrode.

a. Capacitive Coupling-Based Touch Sensors Containing an Exterior Conductive Layer and an Interior Conductive Layer

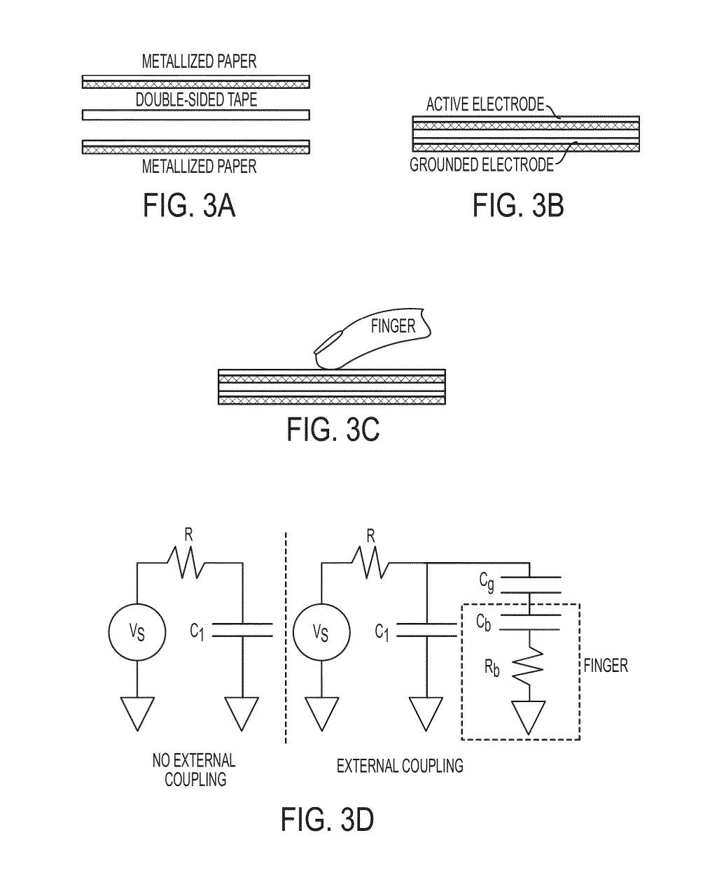

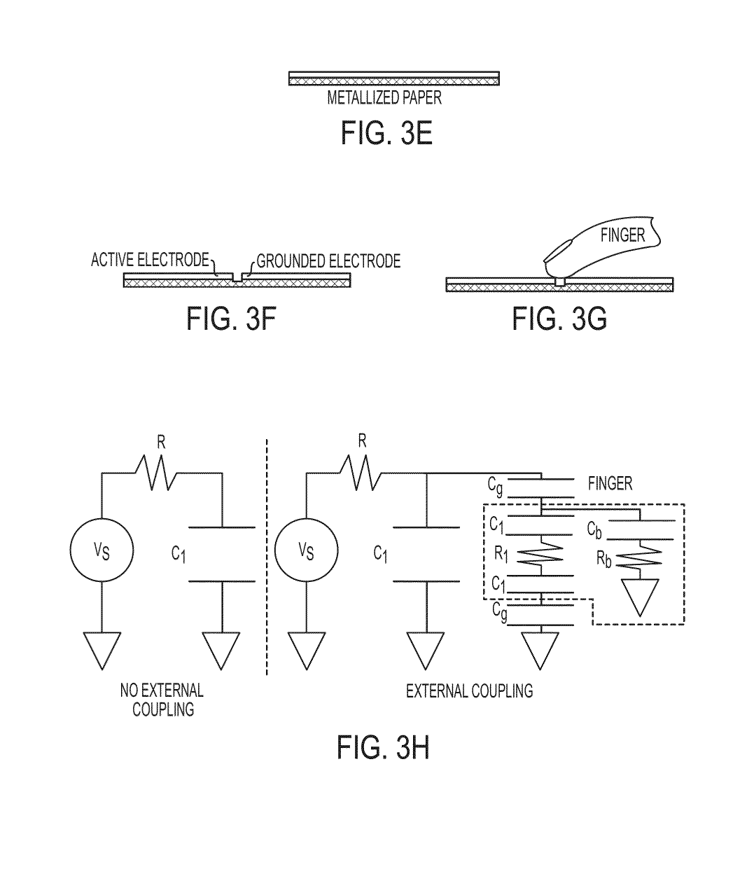

A representative capacitive coupling-based touch sensor containing an exterior conductive layer and an interior conductive layer is illustrated in FIGS. 3A-D and FIGS. 5A-B.

In these embodiments, the touch sensor contains a first conductive layer located on or near the exterior surface of the touch sensor (termed the exterior conductive layer), and a second conductive layer within the sensor interior (termed the interior conductive layer), arranged parallel with the first conductive layer so as to form a parallel plate capacitor. The two conductive layers are separated by a dielectric medium, such as a spacer formed from substrate material, air, or a combination thereof. In some cases, the width of the spacer material is selected so as to provide a capacitance suitable for device function. In certain embodiments, the spacer has a thickness of between 10 and 500 microns, more preferably between 25 and 400 microns, most preferably between 45 and 350 microns. In some embodiments, the spacer has a thickness of between 45 and 55 microns. In some embodiments, the spacer has a thickness of between 45 and 145 microns.

In some cases, the composition of the spacer material is selected so as to have a dielectric constant sufficient to provide a capacitance suitable for device function. In certain embodiments, the substrate material has a static relative permittivity of less than 5, more preferably less than 4.5, most preferably less than 4.

The conductive layers present in the touch sensors can be formed from any suitable conductive material, such as a metal (for example, Sn, Zn, Au, Ag, Ni, Pt, Pd, Al, In, Cu, and alloys thereof), graphite powder, or carbon black. The layer will preferably be of uniform thickness. In certain embodiments, the conductive layer is a thin metallic film which is less than 10 microns in thickness, more preferably less than 1 micron in thickness, more preferably less than 100 nm in thickness, most preferably less 50 nm in thickness. In certain embodiments, the conductive layer is a thin metallic film which is less than 25 nm in thickness. In certain embodiments, the conductive layer is a thin metallic film which is less than 20 nm in thickness.

In some instances, the exterior conductive layer is located within 50 microns of the surface of the touch sensor, more preferably within 25 microns of the surface of the touch sensor, more preferably within 10 microns of the surface of the touch sensor, most preferably within 5 microns of the surface of the touch sensor. The exterior conductive layer is preferably coated with one or more thin films of an insulating material, such as an insulating polymer. The insulating thin film covers the exterior conductive layer, and serves to prevent a user's finger from making direct, conductive contact with the top plate of the capacitor. In some embodiments, the insulating thin film is less than 25 microns thick, more preferably less than 10 microns thick, most preferably less than 5 microns thick. In some cases, one or more layers of material containing graphics or text, for example to indicate the function of the touch sensor, are located on top of the exterior conductive layer.

When an object with a relatively large capacitance, such as the finger of a user, is brought into close proximity to the surface of the sensor, the capacitance of the touch sensor is perturbed by the finger, which functions as an electrode connected to ground with an approximate capacitance (C_{b}) of 100 pF and an approximate resistance (R_{b}) of 1.5 kOhms. As the distance between the finger and the exterior conductive layer becomes small, the capacitance of the touch sensor increases. In a preferred embodiment, the touch sensor is constructed so that a finger covered by an insulating glove, such as a latex or nitrile glove, can operate the touch sensor.

In some embodiments, one or more electrical device components (in addition to the conductive layers) are incorporated into the touch sensor. In some embodiments, conductive materials are patterned on or through one or more substrate materials so as to facilitate contact of the conductive layers with electrical leads, wires, or circuit components.

In some cases, the touch sensor is integrated into an RC circuit, as shown in FIG. 3D, which is used to monitor changes in capacitance. As the capacitance of the touch sensor increases, the time required to fully charge the capacitor with an applied voltage (Vₛ) increases. At sufficiently high oscillatory frequencies dictated by the RC time constant (the product of resistance and capacitance), the potential across the capacitor lags that of the oscillating potential (Vₛ). The lagging behavior results in a measured attenuation of the potential across the capacitor (i.e., the applied voltage switches direction before the capacitor can fully charge). In certain embodiments, the measured attenuation of the potential across the capacitor is correlated with the force applied to the surface of the touch sensor, so as to quantify the force applied to the surface of the touch sensor. In preferred embodiments, the touch sensor operates as a switch (such as a key in a key board). In these embodiments, the potential across the capacitor is monitored, and when the attenuated potential across the capacitor falls below one or more preselected thresholds, the electronics signal the activation of one or more buttons. In some embodiments, the threshold value is 95%, 90%, 85%, 80%, 75%, or 70% of the potential across the untouched capacitive system. The threshold value is selected to provide the desired on-off sensitivity for the touch sensor, and can vary depending upon application.

In a preferred embodiment, the touch sensor is fabricated by stacking two pieces of metallized paper on top of one another, optionally with a spacer layer included between the two sheets of metallized paper. When present, the spacer layer may be, for example, double-sided carpet tape.

b. Capacitive Coupling-Based Touch Sensors Containing Both an Active Electrode and a Grounded Electrode in Proximity to the Surface

A representative capacitive coupling-based touch sensor containing both an active electrode and a grounded electrode positioned in proximity to the surface of the touch sensor is illustrated in FIGS. 3E-H and FIGS. 5D-E.

In these embodiments, both an active electrode and a grounded electrode are positioned in proximity to the surface, such that an object contacting the touch sensor, such as a finger, provides capacitive coupling between the active electrode and the grounded electrode.

An exemplary sensor was formed from a single sheet of metallized paper. The active and grounded electrodes were patterned on the metallized paper by using a laser cutter to etch or ablate lines through the conductive metal layer of the metallized paper to remove a portion of the conductive layer without cutting through the paper. The conductive material was ablated to form two regions of conductive material (i.e., the active and grounded electrodes) that are no longer in direct conductive contact. The width of the gap formed by ablation between the active and grounded electrode is small enough to allow a finger to bridge the gap between the active and grounded electrode. In some cases, the gap between the active and grounded electrode is between 25 microns and 1 mm. In certain embodiments, the width of the gap formed by ablation between the active and grounded electrode is small enough to form a capacitor between the parallel edges of the active and grounded electrode. In preferred embodiments, the width of the gap between the active and grounded electrode is less than 250 microns, more preferably less than 200 microns, most preferably less than 150 microns. In certain embodiments, the width of the gap between the active and grounded electrode is between 75 and 125 microns.

Preferably, the two electrodes are fabricated in an interdigitated fashion as shown in FIGS. 5D and 5E. The interdigitated electrode design increases the capacitive coupling between the active and grounded electrodes when a finger is in proximity to the surface of the button relative to a corresponding non-interdigitated electrode formed by the outer boundaries of the interdigitated electrode. The length of the interface between the interdigitated active and grounded electrode is at least 10% greater, more preferably at least 25%, most preferably at least 50% greater, than the perimeter of a corresponding non-interdigitated electrode with a shape formed by the outer boundaries of the interdigitated electrode.

The conductive layer present in the touch sensor can be formed from any suitable conductive material, such as a metal (for example, Sn, Zn, Au, Ag, Ni, Pt, Pd, Al, In, Cu, and alloys thereof), graphite powder, or carbon black. The layer will preferably be of uniform thickness. In certain embodiments, the conductive layer is a thin metallic film which is less than 10 microns in thickness less than 1 micron in thickness, less than 100 nm in thickness, less 50 nm in thickness, less than 25 nm in thickness, or less than 20 nm in thickness.

In some instances, the conductive layer is located within 50 microns of the surface of the touch sensor, more preferably within 25 microns of the surface of the touch sensor, more preferably within 10 microns of the surface of the touch sensor, most preferably within 5 microns of the surface of the touch sensor. The conductive layer is preferably coated with one or more thin films of an insulating material, such as an insulating polymer. The insulating thin film covers the conductive layer, and serves to prevent a user's finger from making direct, conductive contact with the active and grounded electrodes. In some embodiments, the insulating thin film is less than 25 microns thick, more preferably less than 10 microns thick, most preferably less than 5 microns thick. In some cases, one or more layers of material containing graphics or text, for example, to indicate the function of the touch sensor, are located between the surface of the touch sensor and the conductive layer.

In order to prevent changes in device performance over time, the gap between the active electrode and the grounded electrode can be filled with a suitable dielectric material, such as a polymer. In some cases, the dielectric material is selected so as to have a dielectric constant sufficient to provide a capacitance suitable for device function. In certain embodiments, the substrate material has a static relative permittivity of less than 5, more preferably less than 4.5, most preferably less than 4.

In some cases, the touch sensor is integrated into an RC circuit, which is used to monitor changes in capacitance. As the capacitance of the touch sensor increases, the time required to fully charge the capacitor with an applied voltage (Vₛ) increases. At sufficiently high oscillatory frequencies dictated by the RC time constant (the product of resistance and capacitance), the potential across the capacitor lags that of the oscillating potential (Vₛ). The lagging behavior results in a measured attenuation of the potential across the capacitor (i.e., the applied voltage switches direction before the capacitor can fully charge). In certain embodiments, the measured attenuation of the potential across the capacitor is correlated with the force applied to the surface of the touch sensor, so as to quantify the force applied to the surface of the touch sensor. In preferred embodiments, the touch sensor operates as a switch (such as a key in a key board). In these embodiments, the potential across the capacitor is monitored, and when the attenuated potential across the capacitor falls below one or more preselected thresholds, the electronics signal the activation of one or more buttons. In some embodiments, the threshold value is 95%, 90%, 85%, 80%, 75%, or 70% of the potential across the untouched capacitive system. As discussed above, the threshold value will be selected so as to provide the desired on-off sensitivity for the touch sensor, and can vary depending upon application.

In a preferred embodiment, touch sensor is fabricated from a single piece of metallized paper. In a preferred embodiment, a laser cutter is used to etch or ablate lines through the conductive metal layer of the metallized paper to remove a portion of the conductive layer without cutting through the paper, forming an interdigitated active and grounded electrode.

3. Arrays of Touch Sensors

In some embodiments, multiple touch sensors are combined to form an array of touch sensors. The multiple touch sensors can be formed completely independent from one another (i.e., they do not share any continuous structural layers), and are affixed to a surface, for example using an adhesive, to construct an array of touch sensors. The array of sensors may form, for example, a keyboard (such as a QWERTY keyboard), touchpad, or other data entry device when integrated with suitable electronic components for monitoring changes in capacitance. In preferred embodiments, one or more monolithic pieces of substrate material are patterned to form multiple touch sensors within one or more continuous pieces of substrate material. In these embodiments, multiple touch sensors are formed on one multilayer piece of substrate material.

In some embodiments, the multiple touch sensors are electronically independent of one another. In other embodiments, the multiple touch sensors can share one or more electrical device components. In certain embodiments where multiple sensors based on capacitive coupling are fabricated using one or more monolithic pieces of substrate material, the sensor array may be formed from multiple electrically independent active electrodes and one or more grounded electrodes that is capable of capacitively coupling to more than one active electrode.

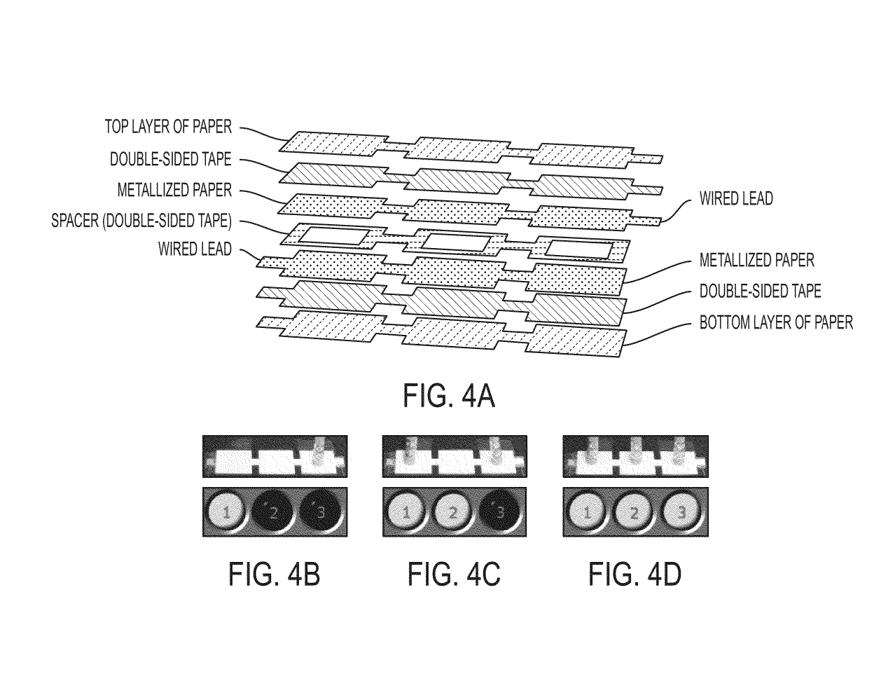

In some embodiments, the array of sensors may form, for example, a keyboard (such as a QWERTY keyboard), trackpad, touchpad, or other data entry device when integrated with suitable electronic components for monitoring changes in capacitance. Exemplary arrays of sensors are illustrated in FIGS. 4A-D, 8A-D, 9A-C and 10A-D

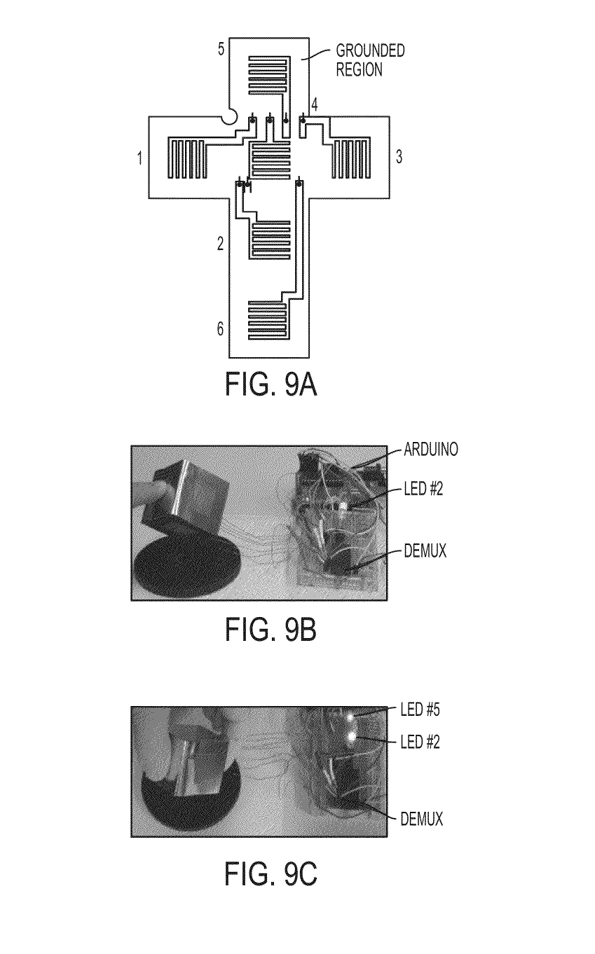

In some embodiments, multiple touch sensors are formed within one or more continuous pieces of substrate material, which is then folded to adopt a 3-dimensional structure. For example, multiple touch sensors can be arranged in a 3-dimensional, orthogonal configuration to form a cube (or other three dimensional shape) with touch sensors located on one or more faces of the three-dimensional shape. Exemplary sensors of this type are illustrated in FIGS. 9A-C, in which multiple touch sensors are arranged on the faces of a closed cubical structure. The cubic architecture advantageously provides increased structure and strength to the 3-dimensional touch sensor. In some cases, multiple touch sensors and electrical device components are first fabricated, and then folded into a 3-dimensional, configuration.

C. Substrate Materials

A variety of materials may serve as a substrate material for the fabrication of the touch sensors described above. Suitable substrate materials include materials which are flexible and electrically insulating. For certain applications, it is preferable that the substrate material can be folded or otherwise mechanically shaped to impart structure and function to the accelerometers or touch sensors. For example, in some embodiments, an array of accelerometers or touch sensors is folded to construct a three-dimensional array.

Non-limiting examples of substrate materials include cellulose, derivatives of cellulose such as nitrocellulose or cellulose acetate, paper (e.g., filter paper, chromatography paper), thin films of wood, natural fabrics (e.g., fabrics formed from naturally occurring fibers such as cotton, wool, lyocell, and silk) and synthetic fabrics (e.g., fabrics formed at least partially from one or more synthetic fibers such as rayon, polyesters, polypropylene, acrylic, and other synthetic polymers), and paper products coated with one or more polymeric or wax coatings, such as wax paper or waterproof paper.

In one embodiment, the substrate material is paper. Paper is inexpensive, widely available, readily patterned, thin, lightweight, and can be disposed of with minimal environmental impact. Furthermore, a variety of grades of paper are available, permitting the selection of a paper substrate with the weight (i.e., grammage), thickness and/or rigidity and surface characteristics (e.g., chemical reactivity, hydrophobicity, and/or roughness), desired for the fabrication of a particular device. Suitable papers include, but are not limited to, chromatography papers, card stock, filter paper, vellum paper, printing papers, wrapping papers, ledger paper, bank paper, bond paper, drawing papers, fish paper, wax paper, and photography papers. These can also be formed in a manner increasing rigidity, such as by pleating, providing struts, or lamination.

In some embodiments, the substrate material is paper having a grammage, expressed in terms of grams per square meter (g/m²), of greater than 75, 100, 125, 150, 175, 200, 225, or 250.

In certain embodiments, the substrate material is a paper or fabric to which a conductive layer or coating has already been applied or inserted. In such embodiments, the conductive layer present on or near the substrate surface can optionally function as a conductive layer in the accelerometer or touch sensor. Examples include metallized papers, such as Vacumet® A-238 or Vacumet® A-550, produced by Vacumet® Paper (Franklin, Mass.). In some embodiments, the substrate may be a paper which contains two or more coatings, such as a polymer coating and a metal coating. In certain embodiments, the substrate material is a metallized polymer film, such as a metallized polyester film. Examples include metallized biaxially-oriented polyethylene terephthalate, such as Mylar® film (DuPont, Wilmington, Del.).

In certain embodiments, the substrate material is a paper or fabric to which one or more adhesive coatings have already been applied. Examples include single- and double-sided tapes, such as carpet tapes. These materials can conveniently serve as a spacer layer between a fixed layer and deflectable layer.

In certain embodiments, the substrate material is a paper or fabric to which one or more adhesive coatings have already been applied. Examples include single- and double-sided tapes, such as carpet tapes. These materials can conveniently serve as a spacer layer between a fixed layer and deflectable layer.

In certain embodiments, the Young's modulus of the substrate material is less than the Young's modulus of single crystalline silicon. In some cases, the Young's modulus of the substrate material is 25 times less, more preferably 40 times less, most preferably 50 times less than the Young's modulus of single crystalline silica. In certain embodiments, the Young's modulus of the substrate material is less than about 150 GPa, 125 GPa, 100 GPa, 90 GPa, 80 GPa, 70 GPa, 60 GPa, 50 GPa, 40 GPa, 30 GPa, 25 GPa, 20 GPa, 15 GPa, 10 GPa, or 5 GPa. In some embodiments, the Young's modulus of the substrate material is greater than about 0.5 GPa, 1 GPa, 1.5 GPa, 2 GPa, 2.5 GPa, 3 GPa, 3.5 GPa, 4 GPa, 5 GPa, 10 GPa, 15 GPa, 20 GPa, 25 GPa, or 30 GPa. In some instances, the Young's modulus of the substrate material is between about 0.5 GPa and 150 GPa, or between any two Young's modulus values within that range.

In certain embodiments, the substrate material has a thickness of less than 500 microns, more preferably less than 300 microns, more preferably less than 250 microns, more preferably less than 200 microns, more preferably less than 150 microns, more preferably less than 100 microns.

1. Modification of the Hydrophobicity of Paper Substrates

Many suitable substrate materials, including many papers, are hydrophilic and will readily absorb water present in the environment. In some cases, this may result in undesirable changes in the mechanical and/or electrical properties of a device fabricated using such a substrate. To address this concern, the substrate material can be covalently or non-covalently modified to alter the hydrophobicity/hydrophilicity of the material.

a. Covalent Modification

In certain embodiments, the substrate material is covalently modified to increase the hydrophobicity of the surface. For example, hydroxyl groups present on the surface of a paper substrate material may be covalently functionalized to increase the hydrophobicity of the material.

In one embodiment, the surface hydroxyl groups of the paper substrate material (i.e., the cellulose fibers) are reacted with a linear or branched alkyl-, fluoroalkyl-, or perfluoroalkyl-trihalosilane, to form surface silanol linkages. In preferred embodiments, the surface of the paper is reacted with one or more fluoroalkyl-, or perfluoroalkyl-trichlorosilanes, such as (tridecafluoro-1,1,2,2-tetrahydrooctyl) trichlorosilane, to form a fluorinated, highly textured, hydrophobic surface on the paper substrate.

In another embodiment, the surface hydroxyl groups of the paper substrate material are acylated by reaction with one or more hydrophobic groups functionalized with an acid chloride. In preferred embodiments, the hydrophobic functional group is an aryl ring substituted with one or more fluorine atoms and/or triflurormethyl groups or a linear or branched alkyl group substituted with one or more halogen atoms. The introduction of halogenated functional groups via glycosidic linkages can increase the hydrophobicity of the paper surface.

b. Non-Covalent Modification

The hydrophobicity of the substrate material can also be increased through non-covalent modification of the surface. For example, the surface of the substrate material can be coated with one or more hydrophobic materials, such as waxes or hydrophobic polymers such as Teflon®. Non-covalent coatings can be applied to the paper surface using a variety of techniques known in the art, including, but not limited to, painting, dipping, spraying, spin-casting, and brushing.

c. Characterization of the Substrate Hydrophobicity

The hydrophobicity/hydrophilicity of the substrate can be quantitatively assessed by measuring the contact angle of a water droplet on the substrate surface using a goniometer. In some embodiments, the substrate has a contact angle of less than 90° (i.e., it is hydrophilic). In certain embodiments, the substrate has a contact angle of more than 90° (i.e., it is hydrophobic). In some embodiments, the substrate has a contact angle of more than 100°, 105°, 110°, 115°, 120°, 125°, 130°, 135°, 140°, 145°, 150°, or 155°. In preferred embodiments, the substrate material has a contact angle of more than 130°.

2. Modification of Substrate Rigidity

The rigidity of the substrate material can also be modified as required for device performance. The rigidity of the paper substrate can be modified by coating the substrate with one or more polymeric materials.

In some cases, part or all of the substrate material can be affixed to a support material designed to increase the rigidity of the substrate. Examples of suitable support materials include polymer films, metal films, semiconductors, and glass. The substrate material can be attached to the support material using a variety of conventional adhesives as described below.

3. Modification of Paper Substrates During Papermaking

In some cases, the paper substrate is modified during the papermaking process to provide the hydrophobicity, rigidity, and/or surface chemistry desired for device fabrication.

For example, the pulp fibers used to make the paper substrate are chemically modified, for example, by covalent substitution of one or more of the hydroxyl groups on the cellulose backbone, prior to or during the paper making process. Covalent modification of the cellulose can serve to increase the hydrophobicity or hydrophilicity of the resulting paper substrate.

In some cases, one or more agents can be incorporated during the paper manufacturing process to increase the strength and rigidity of the paper substrate. Examples include cationic, anionic, and amphoteric polymers including charged polyacrylamides.

4. Modification to Increase Adhesion

The surface of the substrate material can be treated to improve adhesion of the substrate material to the conductive surfaces, electrical device components, proof masses, adhesives, support materials, and/or other surfaces. For example, the paper surface may be treated with a suitable chemical adhesion promoter or plasma prior to application of an adhesive or electrical device component.

D. Conductive Materials

Conductive materials can be patterned on the surface of substrate materials to form conductive layers, electrodes, and other electrical device components.

Non-limiting examples of electrically conductive materials which can be applied to the surface of the substrate material to form a conductive layer or other electrical device component include metals, conductive polymers, conductive greases, conductive adhesives, other suitable materials that are electrically conductive, as well as combinations thereof

In one or more embodiments, the conductive material includes one or more metals. Non-limiting examples of suitable metals include Sn, Zn, Au, Ag, Ni, Pt, Pd, Al, In, Cu, or a combination thereof. In certain embodiments, the conductive material is a conductive ink which can be screen printed, ink jetprinted, or otherwise deposited onto the surface of the substrate material to form an electrical device component. Conductive inks are typically formed by blending resins or adhesives with one or more powdered conductive materials such as Sn, Zn, Au, Ag, Ni, Pt, Pd, Al, In, Cu, graphite powder, carbon black, or other conductive metals or metal alloys. Examples include carbon-based inks, silver inks, and aluminum inks.

In other embodiments, the conductive materials include conductive polymers. Non-limiting examples of conductive polymers include polyacetylenes, polypyrroles, polyanilines, poly(thiophene)s, poly(fluorene)s, poly(3-alkylthiophene)s, polytetrathiafulvalenes, polynaphthalenes, poly(para-phenylene sulfide), poly(para-phenylene vinylene)s, or any combination or derivative thereof

In yet other embodiments, the conductive materials include conductive grease, conductive adhesive, or other suitable material that is electrically conductive.

When forming a conductive layer, one or more conductive materials will preferably be deposited or applied as a thin film. In certain embodiments, the conductive layers are thin metallic films which are less than 10 microns in thickness, more preferably less than 1 micron in thickness, more preferably less than 100 nm in thickness, most preferably less 50 nm in thickness. In certain embodiments, the conductive layers are thin metallic films which are less than 25 nm in thickness. In certain embodiments, the conductive layers are thin metallic films which are less than 20 nm in thickness.

E. Insulating Materials

In some cases, insulating materials may be incorporated between conductive features patterned on a substrate material. In the case of touch sensors that operate using capacitive coupling, the exterior conductive layer of the touch sensor will preferably be covered with a thin film of an insulating material.

In addition, it may also be desirable to cover one or more electrical device components, such as a signal processing circuit, with an insulating material to provide protection from wear and/or environmental conditions. In some embodiments, all of the electrical device components patterned on the substrate surface are covered with a protective layer of one or more insulating materials. In other embodiments, one or more entire surfaces of the touch sensor is covered with a protective layer of one or more insulating materials.

Suitable insulating materials include, but are not limited to insulating adhesive tapes, such as Scotch Tape, conventional varnishes, and polymers, such as polystyrene, polyethylene, or polyvinylchloride.

F. Adhesives

Adhesives may be used to provide a bond between one or more layers within an accelerometer or touch sensor. In addition, adhesives may be applied to one or more portions of an accelerometer or touch sensor to affix, for example, circuitry components or support materials to the substrate material. In addition, adhesive may be applied to the device to adhere it to a surface.

Suitable adhesives are known in the art, and can be selected based on the application and on the two materials being joined. The adhesive can be, for example, a thermoplastic, thermoset, pressure sensitive, or radiation curable adhesive. In some embodiments, the adhesive is a reactive urethane or epoxy adhesive.

Electronic components can be attached to paper substrates using commercially available conductive epoxies. Conductive epoxies are ideal for bonding to paper substrates because they can be applied and cured at room temperature, and require no flux.

### III. Methods of Fabricating Accelerometers and Touch Sensors

Fabrication of the devices described herein, accelerometers and touch sensors, can involve fabrication of the substrate material to form one or more layers of the device (e.g., the fixed layer, the deflectable layer, and the spacer layer), patterning of conductive surfaces or electrical device components on the surfaces of the substrate material, adhering one or more substrate layers together to form an accelerometer or touch sensor, adhering one or more electrical device components, such as signal processing circuitry, to the substrate material, and/or post-fabrication processing. In preferred methods, the fixed layer, spacer layer, and deflectable layer are individually patterned, and subsequently adhered to form the device.

In some cases, it may be preferred to pattern one or more electrical device components on the surface of the substrate material prior to fabricating the substrate material into the desired shape. Alternatively, the substrate material may be fabricated into the desired shape prior to the patterning of electrical device components.

In some embodiments, metallized paper is used to fabricate the fixed layer and deflectable layer of the device. In this case, application of a conductive surface coating may not be required. In some cases, a double-sided tape, such as carpet tape, is used to fabricate the spacer layer. In these instances, the tape substrate provides adhesion between the three layers to form an accelerometer.

Capacitive coupling-based touch sensors containing an exterior conductive layer and an interior conductive layer can be fabricated in a similar fashion to mechanically compliant capacitive touch sensors. Capacitive coupling-based touch sensors containing both an active electrode and a grounded electrode in proximity to the surface of the sensor can be fabricated from a single layer of substrate material. In a preferred embodiment, a touch sensor is fabricated from a single piece of metallized paper. In a preferred embodiment, a laser cutter is used to etch or ablate lines through the conductive metal layer of the metallized paper to remove a portion of the conductive layer without cutting through the paper, forming an interdigitated active and grounded electrode.

A. Methods of Fabricating the Substrate Material

Substrate materials can be fabricated into appropriate two-dimensional shapes for the accelerometers and touch sensors described above using a variety of methods. The substrate material can be mechanically cut, for example, by using a scissor, blade, knife, dye, or punch. Alternatively, the paper substrate can be fabricated using a laser cutter. In certain embodiments, the substrate material may also be perforated to allow the fabrication of circuitry features passing through the substrate material or to facilitate folding or separation of the sensors after fabrication.

If desired, the desired two-dimensional shape required for the device can be designed on a computer using a layout editor (e.g., SolidEdge, Adobe Illustrator, Clewin, WieWeb Inc.). The two-dimensional substrate shape can be printed on to the surface of a desired substrate material using, for example, conventional ink-jet printing or laser printing. Alternatively, the computer can be integrated with a laser cutter to automatically pattern the substrate into the desired shape.

B. Methods of Patterning Electrical Device Components

Electrical device components, including conductive layers, conductive surfaces, and circuitry elements, can be patterned on one or more surfaces of a substrate using methods known in the art.

For example, electrical device components can be deposited onto a substrate surface using stencils. Stencils contain a pattern of holes or apertures having a shape equivalent to one or more features being patterned onto the substrate surface. Conductive and insulating materials can be deposited through the holes or apertures in the stencil onto the substrate surface.

Stencils could be made from a variety of materials such as metal, plastics, or patterned layers of dry-film resist. Non-limiting examples of metals for manufacturing stencils include stainless steel and aluminum. Non-limiting examples of plastic for manufacturing stencils include polyester films such as mylar and vinyl, such as Grafix® Frisket film. Alternatively, patterned layers of dry-film resist can be used as stencils.

Stencils and patterns of metallic pathways, including conductive layers, can be designed on a computer using a layout editor, (e.g., SolidEdge, Adobe® Illustrator, Clewin, WieWeb Inc.) and metal or plastic stencils based on the design can be obtained from a supplier (e.g., Stencils Unlimited LLC (Lake Oswego, Oreg.)). In certain embodiments, the stencil can be removed from the paper after deposition. In certain other embodiments, one side of the stencil is sprayed with a layer of spray-adhesive (e.g., 3M Photomount, 3M Inc.) to temporarily affix the stencil to the paper substrate. After deposition, the stencil can be peeled away from the paper. The stencils can be reused multiple times. In other embodiments, patterned layers of dry-film resist can be used as stencils. Dry film resist can be patterned when exposed to UV light through a transparency mask and developed in dilute sodium hydroxide solution. The patterned dry-film resist can be attached to a coating sheet of plastic or directly affixed to the substrates by pressing the resist-side to the surface of the substrates and passing the multi-sheet structure through heated rollers in a portable laminator (Micro-Mark, Inc). The coating sheet of plastic can then be peeled away, resulting in a sheet of paper with dry film resist patterned on one side.

A variety of techniques can be used to deposit electrical device components onto the substrates through stencils. Non-limiting examples of such techniques include evaporating through stencils, sputter-depositing through stencils, spray depositing through stencils, squeegeeing or screen printing through stencils, or evaporating or sputter-depositing a thin layer of conductive material through stencils

Electrical device components can be evaporated onto the substrate through stencils. Evaporation is a method of thin film deposition in which the source material is evaporated in a vacuum. The vacuum allows vapor particles to travel directly to the target object (substrate), where they condense back into a solid state. Evaporating requires a high vacuum, is applicable to a variety of metals, and can deposit metal at rates of up to 50 nm/s. In certain embodiments, electrical device components such as metals are evaporated onto the substrates through stencils made of metal, plastic, or photoresist. In certain other embodiments, electrical device components are evaporated onto the substrates through stencils made of metal or plastic based on a silk-screen soaked in photoresist. In some cases, a thin layer of an electrical device component is evaporated onto the substrate material, and then a thicker layer of an electrical device component is deposited by electrodeposition or electroless deposition. The metal can be evaporated on a paper substrate material using, for example, an e-beam evaporator. Metals, such as 100% Sn, 100% In, 100% Au, 100% Ag, 52% In-48% Sn Eutectic, 100% Ni and 100% Zn can be patterned onto the substrate surface to create circuitry components using these methods.

Electrical device components can be sputter-deposited onto the substrates through stencils. Sputter deposition is a physical vapor deposition method of depositing thin films by sputtering, i.e., ejecting, the electrical device component from a source onto the substrate material. Sputter-deposition is usually performed at a lower vacuum (>75,000 μTorr) and deposits electrical device components such as metals at a lower rate than evaporation (e.g., 1 nm/s for Au, with lower rates and higher energy requirements for other metals). In certain embodiments, electrical device components such as metals are sputter-deposited onto the substrates through stencils made of metal, plastic, or photoresist. In certain other embodiments, electrical device components are sputter-deposited onto the substrates through stencils made of metal or plastic based on a silk-screen soaked in photoresist. In other cases, a thin layer of an electrical device component is sputter-deposited onto the substrates and then a thicker layer of an electrical device component is deposited by electrodeposition or electroless deposition. The electrical device component can be deposited onto a paper substrate, for example, by sputtering using a Cressington 208HR benchtop sputter coater. Metals, such as 100% Pt, 100% Au, 80% Pd/20% Pt, 100% Ag, 100% Ni, 100% Al and 100% Sn can be patterned onto the substrate surface to create circuitry components using these methods.

Electrical device components can be spray-deposited onto the substrates through stencils. Spray-deposition is quick and inexpensive, and can be applied at room temperature without specialized equipment. Also, because of its large coating thickness, spray deposition of metal can be used to build electrically conductive pathways on very rough surfaces including toilet paper, paper towel, or woven fabric. The spray is applied via an airbrush or an aerosol container consisting of flakes or particles of one or more conductive materials such as metals suspended in an acrylic base. In certain embodiments, electrical device components such as metals are spray-deposited onto the substrates through stencils made of metal, plastic, or photoresist. In certain other embodiments, conductive materials are spray-deposited onto the substrates through stencils made of metal or plastic based on a silkscreen soaked in photoresist. In one case, Ni or Ag is sprayed onto a substrate material and cured at room temp for ten minutes to produce an electrically conductive surface (thickness=20-100 microns depending on number of passes, surface resistance=0.7 Q/square for Ni, 0.01 Q/square for Ag).

Electrical device components can be squeegeed or screen printed onto the substrates through stencils. Non-limiting examples of electrical device components that can be squeegeed or screen printed onto the substrates include conductive adhesives, piezoresistive materials, or conductive inks (metal or conductive polymer based). Squeegee techniques can be used to deposit the electrical device component on the surface of the substrate material. In certain embodiments, conductive materials such as metals are wiped or smoothed onto the substrates through stencils made of metal, plastic, or photoresist. In certain other embodiments, conductive materials are squeegeed onto the substrates through stencils made of metal or plastic based on a silkscreen soaked in photoresist.

Conductive materials can be deposited onto the substrates using an etching process through stencils. In certain embodiments the electrical device component is first deposited onto the substrate material by evaporation, sputter-deposition, spray-deposition, or squeegee. A stencil is then applied, and the portion of the electrical device component that is not protected by the stencil is etched, resulting in a pattern of the electrical device component on the substrate material. A laser cutter or other energy source can also be used to selectively ablate the conductive layer, forming the requisite pattern of conductive material.

Electrical device components can be deposited by drawing features on substrate material. For example, conductive materials can be deposited onto the substrate surface using pens filled with conductive metal inks. In certain embodiments, Ag, Al, Ni, or conductive polymers are applied to the substrate material using a pen or drawing implement filled with an ink containing these materials. Drawing conductive pathways could deposit conductive materials both on the surface and inside the matrix of the substrates.

Electrical device components can also be deposited by inkjet printing, laser printing, or flexographic printing. In certain embodiments, electrical device components are printed or plotted by inkjet or laser printing.

In yet other embodiments, electrical device components are deposited by attaching commercially available or homemade conductive tapes onto the substrate surface. For example, a conductive tape, such as a commercially available copper tape, can be applied to the surface to create a circuitry element. In certain other embodiments, a homemade conductive tape is affixed onto the surface of the substrate material. Homemade conductive tapes can be fabricated from a plastic tape, such as scotch tape, coated with one or more conductive materials by evaporation, sputter deposition, spray-deposition or squeegee.

Conductive materials can be embedded in the pulp or fibers for manufacturing the substrate material to allow for manufacturing substrates with conductive materials deposited within. In certain embodiments, metals or other conductive materials are embedded in the pulp or fibers used for manufacturing paper.

In another aspect, electrical components are attached onto the substrates after the deposition of conductive materials. The electrical components can be attached using known adhesives. In certain embodiments, a commercially available two-part conductive adhesive can be prepared by mixing appropriate volumes of the adhesive components. This adhesive can be used immediately after mixing and is applied to the conductive material pathway using a syringe needle. Discrete electronic components are bonded to the metallic pathways by pressing the terminals of the electronic component on the adhesive. Non-limiting examples of electronic components include integrated circuits, resistors, capacitors, transistors, diodes, mechanical switches, and batteries.

After application, the electrical device component can be cured if necessary. The term “cured” as used herein refers to conductive ink that has been reacted to stabilize the ink on the substrate material surface. In some cases, the conductive ink may be cured using heat, radiation (i.e., UV), or chemical curing methods. Where elements meet on the substrate surface, the features may optionally contain a diffusion zone. For example, where an electrical contact and a conductive surface meet, metal from the electrical contact may diffuse to form a mixture of metal in zones around the interface between the electrical contact and the conductive surface.

Adhesives can be applied to the touch sensor(s) using methods known in the art, for example, by rotogravure printing, knife coating, powder application, or spray coating. Suitable methods of application can be selected based on the surface(s) to the coated as well as the nature of the adhesive being applied.

In some cases, one or more of the features on the device is coated, for protection, with a layer of varnish, insulating polymer, or other protective material.

C. Post Patterning Fabrication

In some cases, accelerometers are further modified into a three-dimensional sensor in one or more post-patterning fabrication steps. Touch sensors may be further modified to form 2D or 3D arrays of touch sensors in one or more post-patterning fabrication steps.

In some embodiments, multiple two-dimensional force-sensing devices are arranged in a 3-dimensional configuration. For example, multiple 2D sensors are arranged orthogonally so as to measure force along more than one axis simultaneously. Preferably, a two-dimensional array of sensors is fabricated on a paper substrate, which is subsequently folded into a 3D structure to presents three sensors orthogonally. In this way, the MEMS-device is able to simultaneously sense force along three orthogonal directions (x-y-z).

In some embodiments, multiple touch sensors are arranged in a 3-dimensional configuration. Preferably, a two-dimensional array of touch sensors is fabricated on a paper substrate, which is subsequently folded into a 3D structure containing multiple touch sensors.

In some cases, multiple touch sensors are affixed to a surface, for example, using an adhesive, to construct an array of touch sensors. The array of sensors may form, for example, a keyboard (such as a QWERTY keyboard), touchpad, or other data entry device when integrated with suitable electronic components for monitoring changes in capacitance.

Decorative graphics, letters, numbers, other characters, and instructions may be printed on the outermost layer of the touch sensor. Typically, the outermost touch sensor layer will include graphics and/or characters to indicate the location and function of each of the touch sensors.

D. Automated Production

The paper-based accelerometers and touch sensors can be mass produced by incorporating highly developed technologies for automatic paper cutting, folding, and screen-printing. In one embodiment the touch sensors are fabricated on a roll which is then applied in a manner similar to labels, with pre-applied or simultaneously applied adhesive. In certain embodiments, an array of sensors is fabricated to form, for example, a keyboard (such as a QWERTY keyboard), touchpad, or other data entry device when integrated with suitable electronic components for monitoring changes in capacitance. In another embodiment, the touch sensors are applied at the time of manufacture of a product, such as a medical device, smart packaging container, or toy. In another embodiment, the accelerometers are applied at the time of manufacture, for example, when air bags in a car are assembled, toys built, or shipping containers assembled. In certain embodiments, when the accelerometer is applied to an object, electrical device components of the accelerometer make contact with electrical device components in or on the object, completing an electrical circuit.

### IV. Methods of Use

The accelerometers described above can be utilized in any application where conventional accelerometers have proven useful. The accelerometers can be used in, for example, medical devices, industrial controls, automotive components, fitness products, toys, athletic equipment, protective equipment such as helmets and pads, robotics, smart packaging materials, and assistive technology.

The touch sensors described above can be utilized in any application where conventional touch sensors have proven useful. Arrays of multiple electrically independent touch sensors can be used as touchpads, and keyboards in, for example, medical devices, industrial controls, automotive components, fitness products, toys, athletic equipment, protective equipment such as helmets and pads, robotics, smart packaging materials (including pharmaceutical packaging materials), anti-theft devices, data entry applications (particularly secure data entry applications), and assistive technology.

Owing to their low cost, portability, and disposability, accelerometers and touch sensors disclosed herein may be particularly suitable for single-use applications. For example, the accelerometers may be integrated into medical devices. In one embodiment, the accelerometers are integrated into an adhesive patch which is applied to the chest of a patient and interfaced with an automated external defibrillator. In this exemplary embodiment, the accelerometer is used to measure the depth of chest compressions administered during CPR. In certain embodiments, the touch sensors, keyboards, and touchpads are designed for use in conjunction with electronic devices in settings where the transmission of infectious agents is a concern. Examples of such settings include, but are not limited to, healthcare settings such as hospitals, pharmacies, doctor's offices, and operating rooms; laboratories; commercial kitchens; and food packaging and preparation facilities. In some embodiments, the touch sensors, keyboards, and touchpads are disposed of routinely to minimize the spread of infection.

In some embodiments, one or more accelerometers, touch sensors, keyboards, or touchpads are incorporated into a toy or portable gaming device. In other embodiments, one or more accelerometers, touch sensor, keyboards, or touchpads are incorporated into smart packaging or shipping materials. For example, the touchpads and sensors can be integrated into packaging to provide an alert or alarm if a package has been opened or otherwise tampered with.

Using many paper, wood, and fabric substrates, accelerometers and touch sensors can be fabricated which are substantially biodegradable. Substantially biodegradable, as used in this context, refers to a device which in constructed using a biodegradable substrate material. Preferably, the biodegradable substrate material decomposes, for example, when placed in moist soil for a period of one year, more preferably six months, more preferably thirty days.

The present invention will be further understood by reference to the following non-limiting examples.

### Example 1

### Fabrication of a Touch Sensor Based on Mechanical Compliance

An exemplary touch sensor based on mechanical compliance is illustrated in FIGS. 2A-C. This touch sensor was formed from two separate pieces of metallized paper (either Vacumet® A-550 or Vacumet® A-238) and a spacer (either double-sided tape (3M® Indoor Carpet Tape) or Whatman® 3MM chromatography paper). Sheets of metallized paper were cut to form the deflectable plate and the fixed plate. The spacer was cut to provide a gap of air between the fixed and deflectable plates when all three layers were adhered (see also FIG. 4A-D). All layers were cut using a VLS3.50 laser cutter (50-watt laser) from Universal Laser Systems with the standard 2.0″ lens. The three layers were then adhered. In the case of sensors fabricated using chromatography paper as the spacer, double sided tape was applied to the top and bottom of the spacer layer to adhere the fixed layer and deflectable layer. The resulting design permits the distance between the fixed plate and the deflectable plate to change with applied pressure/force, resulting in a change in capacitance.

Silver conductive adhesive 503 from Electron Microscopy Sciences (Hatfield, Pa.) was used to attach wires to the conductive layers of the fixed plate and the conductive plate. The metallized paper contains an insulating polymer thin film that covers the surface of the conductive aluminum. To ensure conductive contact with the conductive aluminum layer of the paper, a portion of the polymeric coating was scraped from the surface before applying the conductive adhesive. In other cases, the polymeric coating was dissolved with acetone before applying the conductive adhesive. It was also found that the conductive adhesive could be applied directly to the metallized paper as the solvent present in the adhesive was able to dissolve away enough of the polymeric coating to form a conductive connection. The capacitance of the touch sensor was measured upon application of a force to the sensor surface. When touched, the capacitance of the sensor increased.

### Example 2

### Fabrication of a Capacitive Coupling-Based Touch Sensor Containing an Exterior Conductive Layer and an Interior Conductive Layer

A representative capacitive coupling-based touch sensor containing an exterior conductive layer and an interior conductive layer is illustrated in FIGS. 3A-D and FIGS. 5A-B. This sensor does not include a gap of air serving as a dielectric material between the two conductive layers. Analogous sensors containing an air gap were also fabricated. These sensors operate using both mechanical compliance and capacitive coupling.

Metallized paper (either Vacumet® A-550 or Vacumet® A-238) was used to form the exterior conductive layer and the interior conductive layer. Both layers were cut using a VLS3.50 laser cutter (50-watt laser) from Universal Laser Systems with the standard 2.0″ lens. The perimeter of the exterior conductive surface was ablated using a laser cutter operated at a reduced power setting sufficient to ablate the conductive layer without cutting completely through the metallized paper. For the Vacumet A-550 metallized paper, we used the setting of 6% power, 80% speed, and 500 pulses per inch. For the Vacumet A-238 metallized paper, we used the setting of 3% power, 80% speed, and 500 pulses per inch. The device shown in FIGS. 5A-B was fabricated using Vacumet® A-238 to form the exterior conductive layer and Vacumet® A-550 to form the interior conductive layer. The two sheets of metallized paper were then adhered using double-sided tape (3M® Indoor Carpet Tape).

Silver conductive adhesive 503 from Electron Microscopy Sciences (Hatfield, Pa.) was used to attach wires to the exterior and interior conductive layers of the touch sensor. The metallized paper contains an insulating polymer thin film that covers the surface of the conductive aluminum. To ensure conductive contact with the conductive aluminum layer of the paper, a portion of the polymeric coating was scraped from the surface before applying the conductive adhesive. In other cases, the polymeric coating was dissolved with acetone before applying the conductive adhesive. It was also found that the conductive adhesive could be applied directly to the metallized paper as the solvent present in the adhesive was able to dissolve away enough of the polymeric coating to form a conductive connection.

To measure the changing capacitance the touch sensor, an Arduino® processor (UNO or MEGA 2560) was connected to the touch sensor. Arduino® microprocessors, in combination with open-source software, provide for simple signal processing and computation. The Arduino® is capable of applying a step input to a resistor and capacitor in series, and measuring the time required for the potential on the capacitor to reach 2 volts.

To measure a change in capacitance of the touch sensor, a 1.01 MOhm resistor (measured with R.S.R 308B Multimeter at 21° C., 50% RH) was placed in series with the capacitive touch sensor. Using Arduino, the amount of time for the potential across the capacitor to reach 2 V was calculated.

The results are shown in FIG. 5C. Each point in the graph is the mean of the touch sensors' capacitance calculated over five seconds of sampling with and without an applied touch. As shown in FIG. 5C, the touch sensor exhibits a change in capacitance when a finger is placed on the surface of the touch sensor. Seven measurements of capacitance (22° C., 50% RH) without the touch sensor being touched had a mean capacitance of 106 pF and a standard deviation of 7.6 pF for n=4746. Seven measurements of capacitance (22° C., 50% RH) while the touch sensor is being touched with a bare finger had a mean capacitance of 171 pF and a standard deviation of 17 pF for n=4634.

### Example 3

### Capacitive Coupling-Based Touch Sensors Containing Both an Active Electrode and a Grounded Electrode in Proximity to the Surface

A representative capacitive coupling-based touch sensor containing both an active electrode and a grounded electrode positioned in proximity to the surface of the touch sensor is illustrated in FIGS. 3E-H and FIGS. 5D-E.

This touch sensor was formed from a single sheet of metallized paper (either Vacumet® A-550 or Vacumet® A-238). The metallized paper was cut to the desired shape using a VLS3.50 laser cutter (50-watt laser) from Universal Laser Systems with the standard 2.0″ lens. The active and grounded electrode were then patterned by ablating the conductive metal layer using the VLS3.50 laser cutter. The laser cutter was operated at a reduced power setting sufficient to ablate the conductive layer without cutting completely through the metallized paper. For the Vacumet A-550 metallized paper, we used the setting of 6% power, 80% speed, and 500 pulses per inch. For the Vacumet A-238 metallized paper, we used the setting of 3% power, 80% speed, and 500 pulses per inch.

Silver conductive adhesive 503 from Electron Microscopy Sciences (Hatfield, Pa.) was used to attach wires to the active electrode and the grounded electrode of the touch sensor. The metallized paper contains an insulating polymer thin film that covers the surface of the conductive aluminum. To ensure conductive contact with the conductive aluminum layer of the paper, a portion of the polymeric coating was scraped from the surface before applying the conductive adhesive. In other cases, the polymeric coating was dissolved with acetone before applying the conductive adhesive. It was also found that the conductive adhesive could be applied directly to the metallized paper as the solvent present in the adhesive was able to dissolve away enough of the polymeric coating to form a conductive connection.

To measure the change in capacitance, the touch sensor, an Arduino® processor (UNO or MEGA 2560) was connected to the touch sensor. Arduino® microprocessors, in combination with open-source software, provide for simple signal processing and computation. The Arduino® is capable of applying a step input to a resistor and capacitor in series, and measuring the time required for the potential on the capacitor to reach 2 volts.

To measure a change in capacitance of the touch sensor, a 1.01 MOhm resistor (measured with R.S.R 308B Multimeter at 21° C., 50% RH) was placed in series with the capacitive touch sensor. Using Arduino®, the amount of time for the potential across the capacitor to reach 2 V was calculated.

The results are shown in FIG. 5F. Each point in the graph is the mean of the touch sensors' capacitance calculated over five seconds of sampling with and without an applied touch. As shown in FIG. 5F, the touch sensor exhibits a change in capacitance when a finger is placed on the surface of the touch sensor. Seven measurements of capacitance (22° C., 49% RH) without the sensor being touched had a mean capacitance of 24.4 pF and a standard deviation of 2.4 pF for n=5564. Seven measurements of capacitance (22° C., 49% RH) with the sensor being touched with a bare finger had a mean capacitance of 1100 pF and a standard deviation of 266 pF for n=3387.

1. Durability

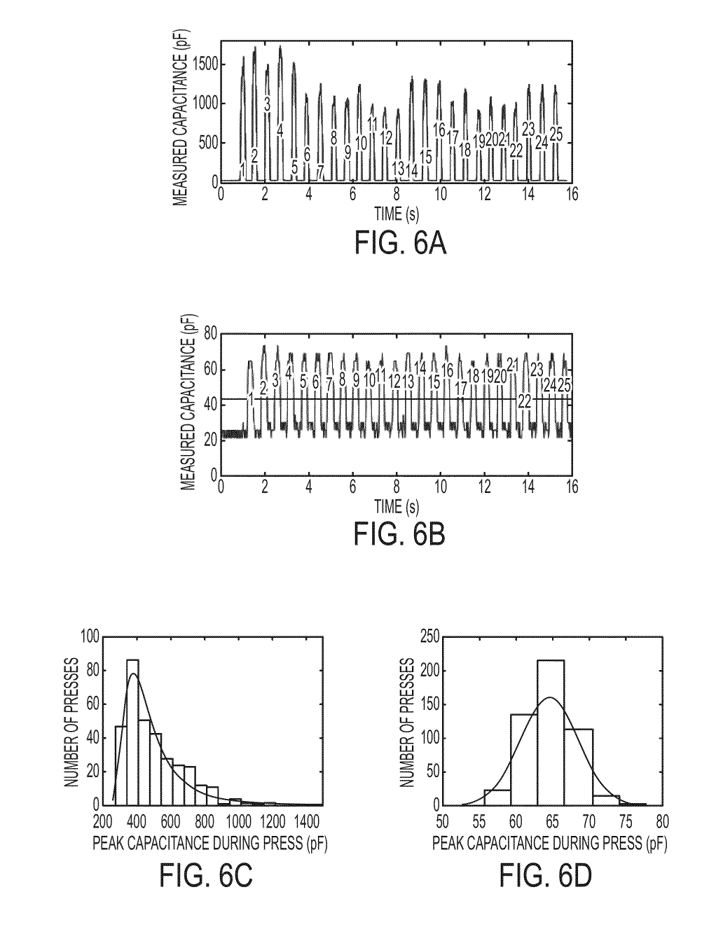

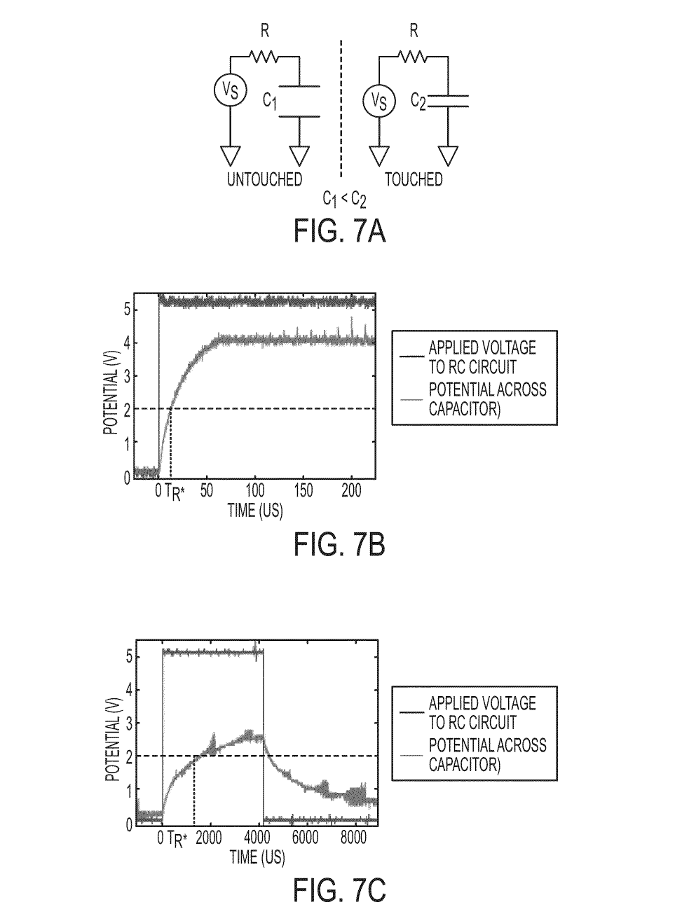

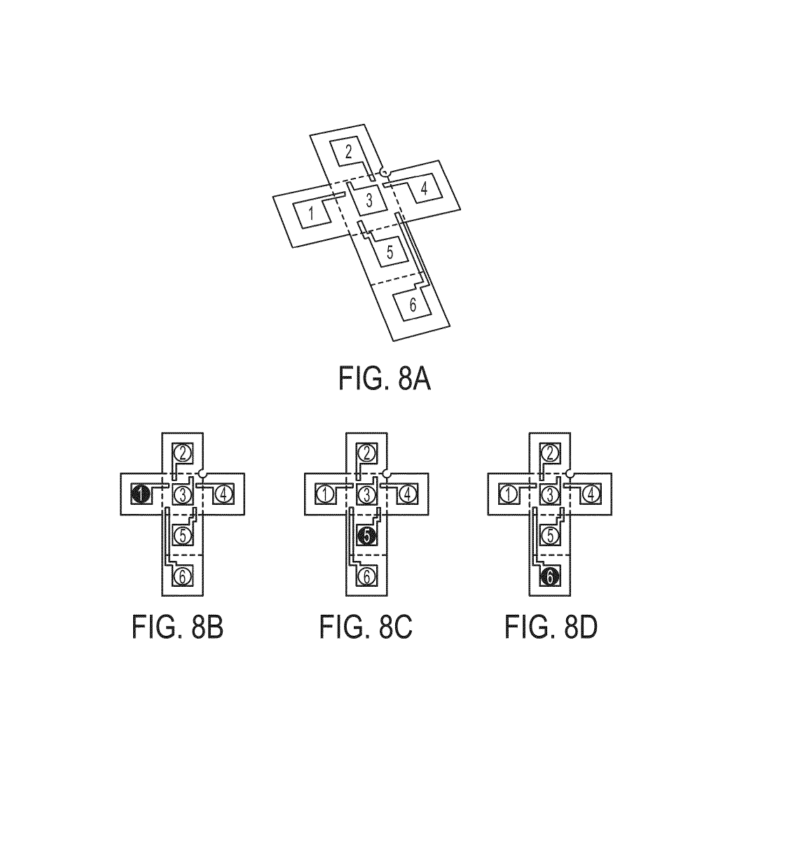

To test the durability of the touch sensor, the touch sensor shown in FIG. 5D was pressed over 2000 times. The sensor continued to function. FIG. 6A-D shows some of the measurements taken with the Arduino®-based system after the touch sensor had already received more than 1000 presses. The crosses and numbers shown in FIGS. 6A and 6B indicate when the Arduino®-based system detected a change in the state of the touch sensor relative to a fixed threshold of 43 pF (threshold of 40 μs for the potential on the capacitor to reach 2 V out of the maximum of 5 V). After the touch sensor had already received over 1000 presses, the touch sensor was pressed 335 times with a bare finger, and the peak capacitance values were recorded during each press (a press occurred when the capacitance exceeded the fixed threshold of 43 pF).

### Example 4

### Fabrication of Capacitive, Paper-Based Touchpads and Keyboards

Touchpads and keyboards contain multiple touch sensors fabricated in a monolithic piece of substrate material or one multilayer piece of substrate material. Exemplary touchpads and keyboards are illustrated in FIGS. 4A-D, 8A-D, and 10A-D.

Touchpads and keyboards were formed using the same methods described in Examples 1-3; however, each layer was fabricated to contain multiple touch sensors as opposed to a single touch sensor. In the case of touchpads and keyboards containing capacitive coupling-based touch sensors containing both an active electrode and a grounded electrode positioned in proximity to the surface, the touchpad or keyboard contained a single grounded electrode and an active electrode for each button or key. In all cases, the buttons or keys individually register a change in capacitance when they are pressed. When integrated with signal processing elements, the touchpads and keyboards could be used for data entry.

Silver conductive adhesive 503 from Electron Microscopy Sciences (Hatfield, Pa.) was used to attach 30-gauge wires to the conductive layers or electrodes. In the case of the QWERTY-based keyboards, silver conductive adhesive 503 from Electron Microscopy Sciences (Hatfield, Pa.) was used to form contact pads for interfacing with contact pads on a PCB board.

The metallized paper contains an insulating polymer thin film that covers the surface of the conductive aluminum. To ensure conductive contact with the conductive aluminum layer(s) of the paper, a portion of the polymeric coating was scraped from the surface before applying the conductive adhesive. In other cases, the polymeric coating was dissolved with acetone before applying the conductive adhesive. It was also found that the conductive adhesive could be applied directly to the metallized paper as the solvent present in the adhesive was able to dissolve away enough of the polymeric coating to form a conductive connection.

To measure the changing capacitance of the buttons and demonstrate interactive applications using paper-based touchpads and keyboards, Arduino® processors (UNO and MEGA 2560) were connected to the touch sensors. Arduino® microprocessors, in combination with open-source software, provides for simple signal processing and computation. The Arduino® is capable of applying a step input to a resistor and capacitor in series, and measuring the time required for the potential on the capacitor to reach 2 volts. To measure a change in capacitance of an individual button, we placed a resistor (typically 100 kOhm or 1 MOhm) in series with a capacitive button and then measured the electric potential across the capacitor. To buffer the potential across the capacitor against the impedance of the Arduino®'s inputs, we used an op amp (LM324) with unity gain. To measure the responses of 10-48 individual buttons with only one to three electrical inputs, a demultiplexing chips (TI CD4067BE 1:16) addressed with four binary outputs was also used.

In the case of the 10-button touchpad, an input and five outputs (one output supplied a stepped signal to the RC circuits and the other four addressed a multiplexer) on the Arduino® processor were used to address all ten keys. The stepped signal from the Arduino® processor went through the same resistor for all ten keys but went through a separate capacitive region as dictated by a 1:16 demultiplexer (TI CD4067BE). In the case of the prototype QWERTY keyboard, the keyboard was interfaced with a PCB board.

### Example 5

### Fabrication of a Three-Dimensional Array of Capacitive, Paper-Based Touch Sensors

Capacitive coupling-based touch sensors were fabricated to form a 3D cube containing capacitive touch sensors on the faces on the cube. Representative 3D touch sensors are shown in FIG. 9A-C.

Touch sensors based on capacitive coupling were fabricated as described in Examples 2 and 3. The array of sensors was first fabricated in a 2D pattern, and folded to form a 3D structure (i.e., a cube).

Silver conductive adhesive 503 from Electron Microscopy Sciences (Hatfield, Pa.) was used to attach 30-gauge wires to the conductive layers or electrodes. In the case of the QWERTY-based keyboards, silver conductive adhesive 503 from Electron Microscopy Sciences (Hatfield, Pa.) was used to form contact pads for interfacing with contact pads on a PCB board.

The metallized paper contains an insulating polymer thin film that covers the surface of the conductive aluminum. To ensure conductive contact with the conductive aluminum layer(s) of the paper, a portion of the polymeric coating was scraped from the surface before applying the conductive adhesive. In other cases, the polymeric coating was dissolved with acetone before applying the conductive adhesive. It was also found that the conductive adhesive could be applied directly to the metallized paper as the solvent present in the adhesive was able to dissolve away enough of the polymeric coating to form a conductive connection.

To measure the changing capacitance of the buttons and demonstrate interactive applications using paper-based touchpads and keyboards, Arduino® processors (UNO and MEGA 2560) were connected to the touch sensors. Arduino® microprocessors, in combination with open-source software, provides for simple signal processing and computation. The Arduino® is capable of applying a step input to a resistor and capacitor in series, and measuring the time required for the potential on the capacitor to reach 2 volts. To measure a change in capacitance of an individual button, we placed a resistor (typically 100 kOhm or 1 MOhm) in series with a capacitive button and then measured the electric potential across the capacitor. To buffer the potential across the capacitor against the impedance of the Arduino®'s inputs, we used an op amp (LM324) with unity gain. To measure the responses of 6 individual buttons with only one to three electrical inputs, a demultiplexing chips (TI CD4067BE 1:16) addressed with four binary outputs was also used.

In the case of the 6-button cube, the three-dimensional keypad detected touches with bare and gloved fingers and lit corresponding LED(s).

### Example 6

### Fabrication of an Alarmed Box Using Capacitive Touch Sensors

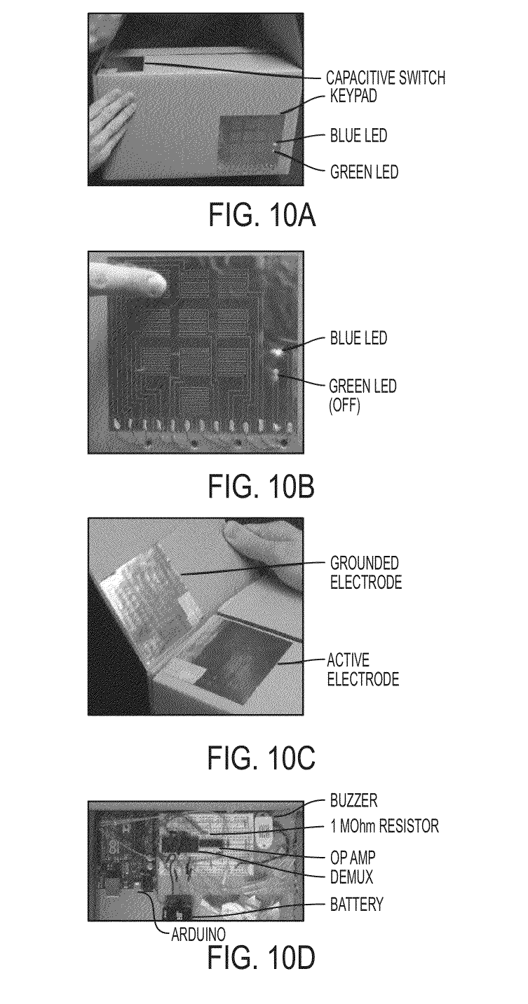

To demonstrate the potential of capacitive, paper-based touch sensors in smart packaging applications, a prototype alarmed box was fabricated as shown in FIGS. 10A-D.

A 10-button touchpad was fabricated as described in Examples 3 and 4. The touchpad was prepared from a single layer of metallized paper and had a thickness of approximately 60 microns. The touchpad and two LEDS were adhered to the exterior of a cardboard box with double-sided tape (FIGS. 10A and B). The touchpad served as the user interface to arm or disarm an alarm built into the box. When armed, the LEDs were off

Opening the top lids on the box caused a decrease in the capacitance between the two pieces of metallized paper taped to the lids (capacitive switch). This decrease in capacitance, unlike the increases experienced by the buttons when touched with a finger, triggered the alarm, sounded a buzzer, and lit up both LEDs on the metallized paper. For purposes of demonstration, closing the lids caused the alarm to stop sounding.

To disarm the alarm, the user entered a numeric code by touching the keys on the touchpad. With every pressing of one of the keys, the blue LED would flash to provide visual feedback to the user. When disarmed, the electronics lit the green LED, and opening the box did not trigger the alarm.

To arm the alarm from the disarmed state, a user hit any button on the keypad, and the LEDs returned to an unlit state.

This alarmed box with thin, sticker-like keypads demonstrates a potential method of securing transported materials.

We claim:

1. A device comprising at least one paper or fabric substrate material having a conductive layer and optionally comprising a parallel plate capacitor.

2. The device of claim 1 comprising a parallel plate capacitor comprising a fixed plate comprising a substrate material having a conductive layer and a free or deflectable plate comprising a paper substrate material having a conductive layer.

3. The device of claim 1 comprising a parallel plate capacitor comprising an exterior conductive layer deposited on a paper substrate material and an interior conductive layer deposited on a substrate material.

4. The device of claim 1 comprising an active electrode and a grounded electrode patterned on the surface of a paper substrate material.

5. The device of claim 2, wherein the fixed plate substrate material is paper or fabric.

6. The device of claim 2, wherein the substrate material of the fixed plate or the free plate is a natural polymer selected from the group consisting of cellulose, wool, silk, cotton, or chemically or structurally modified derivatives thereof.

7. The device of claim 6, wherein the substrate is metallized paper.

8. The device of claim 1, further comprising electrical contacts suitable to connect to a means for measuring the capacitance.

9. The device of claim 1, further comprising an integrated signal-processing circuit for measuring the capacitance.

10. The device of claim 1, wherein the parallel plate capacitor is formed by folding of the substrate material.

11. The device of claim 1, further comprising a spacer separating the fixed plate and the free or deflectable plate.

12. The device of claim 1, further comprising a dielectric medium of air separating the fixed plate and the free or deflectable plate.

13. The device of claim 4, wherein the active electrode and the grounded electrode are interdigitated.

14. The device of claim 4, wherein the active electrode and the grounded electrode are covered by an insulating film.

15. The device of claim 14, wherein the insulating film is a polymer film.

16. The device of claim 4, wherein the gap between the active electrode and the grounded electrode is filled with a dielectric material.

17. The device of claim 1, wherein the device is an accelerometer.

18. The device of claim 1, wherein the device is a touch sensor.

19. An array of accelerometers comprising two or more accelerometers of claim 17.

20. An array of independent touch sensors comprising two or more touch sensors of claim 18.

21. The array of claim 19 or claim 20, wherein the two or more devices are patterned onto a continuous piece of substrate material.

22. The array of claim 21, wherein the substrate material is folded into a three dimensional shape.

23. The array of claim 22, wherein the shape is a cube and the devices are accelerometers positioned orthogonally on the faces of the cube.

24. The array of claim 20, wherein the array of touch sensors forms a keyboard, touchpad, or other data entry device.

25. A method of making a device comprising one or more parallel plate capacitors, comprising patterning one or more layers selected from the group consisting of a paper substrate layer, a fixed substrate layer, a spacer layer, and a free or deflectable substrate layer and joining them together.

26. The method of claim 25, wherein the devices are on a continuous roll.

27. An apparatus having applied thereto one or more devices claim 1.

28. The apparatus of claim 27 wherein one or more electrical device components from one or more of the devices and/or one or more of the arrays make contact with electrical device components in or on the object to complete an electrical circuit.

29. The apparatus of claim 27, wherein the apparatus is selected from the group consisting of medical devices, industrial controls, automotive components, fitness products, toys, athletic equipment, protective equipment, smart packaging materials, and assistive technology.

30. The apparatus of claim 29, wherein the apparatus comprises a toy.

31. The apparatus of claim 29, wherein the apparatus comprises packaging.

32. The apparatus of claim 31, wherein the device indicates whether the package has been opened.

33. The apparatus of claim 29, wherein the apparatus comprises a device or pharmaceutical used or administered by a healthcare provider.

34. A method of generating a signal comprising contacting a touch sensor of claim 18, wherein the touch sensor is a single touch sensor or one of a plurality of touch sensors from an array of touch sensors.

35. A method of sensing acceleration or deceleration, comprising:
detecting a change in capacitance using one or more devices according to claim 1, wherein the device is secured to an article.
